(19) United States
(12) Patent Application Publication
(10) Pub. No.: US 2019/0071934 A1
(43) Pub. Date: Mar. 7, 2019

(54) ROTARY SHOULDER CONNECTIONS FOR THREADED PIPE CONNECTIONS

(71) Applicant: Black Diamond Oilfield Rentals LLC, Houston, TX (US)

(72) Inventors: Christopher M. Biggerstaff, Houston, TX (US); Charles G. Kibbe, New Iberia, LA (US); Jerrod B. Olivier, New Iberia, LA (US)

(73) Assignee: Black Diamond Oilfield Rentals LLC, Houston, TX (US)

(21) Appl. No.: 15/926,431

(22) Filed: Mar. 20, 2018

Related U.S. Application Data
(60) Provisional application No. 62/554,707, filed on Sep. 6, 2017.

(51) Int. Cl. E21B 17/042; F16L 15/00

(52) U.S. Cl. CPC E21B 17/042; F16L 15/00

(57) ABSTRACT

A rotary shoulder connection comprising: a box connection, wherein the box connection has a box outer radius, a box counter bore radius and a box inner radius, and box threads having a box thread form cut along a box taper; a pin connection, wherein the pin connection has a pin nose inner radius, a pin outer radius, a pin cylinder radius and a pin nose radius, and pin threads having a pin thread form cut along a pin taper to align with the box threads inside the box connection; and a primary shoulder connection comprising: a curved primary box shoulder; a curved primary pin shoulder and/or a curved secondary box shoulder and a curved secondary pin shoulder is disclosed. Methods of using the rotary shoulder connection are also disclosed.

### PRIOR RELATED APPLICATIONS

This application claims benefit of U.S. Provisional Patent Application Ser. No. 62/554,707 entitled “IMPROVED ROTARY SHOULDER CONNECTIONS FOR THREADED PIPE CONNECTIONS,” filed on Sep. 6, 2017.

### FEDERALLY SPONSORED RESEARCH STATEMENT

Not Applicable (N/A)

### REFERENCE TO MICROFICHE APPENDIX

N/A

### FIELD OF INVENTION

The present invention relates generally to a rotary shoulder connection and methods thereof and, more particularly, to an improved rotary shoulder connection with primary and secondary curved shoulder features for threaded pipe connections in various drill strings and methods thereof.

### BACKGROUND OF THE INVENTION

Standard (typical) double-shoulder connections and standard (typical) single-shoulder connections suffer from the problem of box “swell” (e.g., box material yields) due to tapered threads, included thread profile angle and high generated axial compressive loads. The box swell forces force the primary shoulder of the box connection outward, causing deformation of and/or permanent damage to the box connection.

Standard (typical) double-shoulder connections and standard (typical) single-shoulder connections also suffer from the problem of pin collapse. The pin collapse forces push a portion of the pin nose inward, causing deformation of and/or permanent damage to the pin connection.

This combination of box swell (e.g., box material yields) and pin collapse can lead to misalignment of the box threads and the pin threads, as well as permanent damage to the box connection and/or the pin connection. Over time, the box threads become misaligned with the pin threads, causing damage to the box threads and/or the pin threads.

Further, this combination of box swell (e.g., box material yields) and pin collapse, in conjunction with high alternating axial, torsional, and bending loads, can lead to premature fatigue failure of the standard (typical) double-shoulder connection and standard (typical) single-shoulder connection, damage to the box threads and/or the pin threads, and permanent deformation of the box connection and/or the pin connection to reduce the effects of box swell (e.g., box material yields) and pin collapse.

Thus, an improved double-shoulder connection and an improved single-shoulder connection are needed to eliminate these problems.

### SUMMARY OF THE INVENTION

In an embodiment, a rotary shoulder connection comprises a curved primary shoulder and/or a curved secondary shoulder.

In an embodiment, the rotary shoulder connection comprises: a box connection having a box axis, wherein the box connection has a box outer radius, a box counter bore radius and a box inner radius, and box threads having a box thread form cut along a box taper; a pin connection having a pin axis, wherein the pin connection has a pin nose inner radius, a pin outer radius, a pin cylinder radius and a pin nose radius, and pin threads having a pin thread form cut along a pin taper to align with the box threads inside the box connection; and a primary shoulder connection at a first end of the box connection and a first end of the pin connection.

In an embodiment, the primary shoulder connection comprises: a primary box shoulder with a first curved profile defined by a primary axial box radius height, a primary box center point and a primary box radius; and a primary pin shoulder with a second curved profile defined by a primary axial pin radius height, a primary box center point and a primary pin radius. In an embodiment, the primary box shoulder contacts the primary pin shoulder to form a first seal.

In an embodiment, the first end point is coplanar with a first reference plane.

In an embodiment, the primary axial box radius height is from about 0.000 inch to about the length of the primary box radius in inches; and the primary axial pin radius height is from about 0.000 inch to about the length of the primary pin radius in inches.

In an embodiment, the primary box center point is located at about half-way between a box counter bore diameter and a pin bevel diameter; and the primary pin center point is located at about half-way between the box counter bore diameter and the pin bevel diameter.

In an embodiment, the primary box radius is greater than about [(pin bevel diameter−box counter bore diameter)/4] inches; and the primary pin radius is greater than about [(box bevel diameter−box counter bore diameter)/4] inches. In an embodiment, the primary box radius is greater than about [(pin bevel diameter−box counter bore diameter)/4] inches. In an embodiment, the primary axial box radius is about equal to the primary pin radius to form the first seal. In an embodiment, the primary box radius is slightly different than the primary pin radius to form the first seal.

In an embodiment, the primary box shoulder is convex shaped and the primary pin shoulder is concave shaped.

In an embodiment, the primary box shoulder has one or more of a first flat region at an inner edge of the first curved profile and a first angled flat region at an outer edge of the first curved profile; and the primary pin shoulder has one or more of a second flat region at an inner edge of the first curved profile and a third flat region at an outer edge of the first curved profile.

In an embodiment, the rotary shoulder connection further comprises: a secondary shoulder connection at a second end of the box connection and a second end of the pin connection. In an embodiment, the secondary shoulder connection comprises: a secondary box shoulder with a third curved profile defined by a secondary axial box radius height, a secondary box center point and a secondary box radius and a secondary pin shoulder with a fourth curved profile defined by a secondary axial pin radius height, a secondary pin center point and a secondary pin radius. In an embodiment, the secondary box shoulder contacts the secondary pin shoulder to form a torque shoulder.

In an embodiment, the second end is offset a first distance from the first end. In an embodiment, the first distance is from about 1 inch to about 8 inches. In an embodiment, the first distance is from about 2 inches to about 8 inches. In an embodiment, the first distance is a connection length.

In an embodiment, the secondary axial box radius height is from about 0.000 inch to about the length of the secondary box radius in inches; and the secondary axial pin radius height is from about 0.000 inch to about the length of the secondary pin radius in inches.

In an embodiment, the secondary box center point is located at about half-way between a pin nose outer diameter and a pin nose inner diameter; and the secondary pin center point is located at about half-way between the pin nose outer diameter and the pin nose inner diameter.

In an embodiment, the secondary box radius is greater than about [(pin nose outer diameter−pin nose inner diameter)/4] inches; and the secondary pin radius is greater than about [(pin nose outer diameter−pin nose inner diameter)/4] inches. In an embodiment, the secondary box radius is about equal to the secondary pin radius to form the torque shoulder. In an embodiment, the secondary box radius is slightly different than the secondary pin radius to form the torque shoulder.

In an embodiment, the secondary box shoulder is concave shaped and the secondary pin shoulder is convex shaped.

In an embodiment, the secondary box shoulder has one or more of a fourth flat region at an inner edge of the second curved profile and a fifth flat region at an outer edge of the second curved profile; and the secondary pin shoulder has one or more of a sixth flat region at an inner edge of the second curved profile and a second angled region at an outer edge of the second curved profile.

In an embodiment, the rotary shoulder connection further comprises: a secondary shoulder connection at a second end of the box connection and a second end of the pin connection. In an embodiment, the secondary shoulder connection comprises: a secondary box shoulder at a secondary box angle with respect to a second perpendicular to the box axis at a second end point and a secondary pin shoulder at a secondary pin angle with respect to the second perpendicular to the pin axis at the second end point. In an embodiment, the secondary box shoulder contacts the secondary pin shoulder to form a torque shoulder.

In an embodiment, the second end is offset a first distance from the first end. In an embodiment, the first distance is from about 1 inch to about 8 inches. In an embodiment, the first distance is from about 2 inches to about 8 inches. In an embodiment, the first distance is a connection length.

In an embodiment, the secondary box angle is from greater than or equal to about 0 degrees to less than or equal to 15 degrees; and the secondary pin angle is from greater than or equal to about 0 degrees to less than or equal to 15 degrees. In an embodiment, the secondary box angle is from greater than or equal to about 0 degrees to less than or equal to 10 degrees; and the secondary pin angle is from greater than or equal to about 0 degrees to less than or equal to 10 degrees. In an embodiment, the secondary box angle is about 5 degrees; and the secondary pin angle is about 5 degrees. In an embodiment, the secondary box angle is about 0 degrees; and the secondary pin angle is about 0 degrees.

In an embodiment, the secondary box angle is about equal to the secondary pin angle to form the torque shoulder. In an embodiment, the secondary box angle is slightly different than the secondary pin angle to form the torque shoulder.

In an embodiment, the secondary box shoulder is conical shaped (outside of cone, male) and the secondary pin shoulder is conical shaped (inside of cone, female).

In an embodiment, the box thread form comprises a first box thread crest, a second box thread crest, a first box thread flank, a second box thread flank, a box included angle between the first box thread flank and the second box thread flank, and a box thread root, and wherein the pin thread form comprises a first pin thread crest, a second pin thread crest, a first pin thread flank, a second pin thread flank, a pin included angle between the first pin thread flank and the second pin thread flank, and a pin thread root.

In an embodiment, the box thread form is selected from the group consisting of square, triangular, trapezoidal, and variations thereof, and the pin thread form is selected from the group consisting of square, triangular, trapezoidal, and variations thereof.

In an embodiment, the first box thread crest and/or the second box thread crest is circular, square, triangular or trapezoidal shaped; and first pin thread crest and/or the second pin thread crest is circular, square, triangular or trapezoidal shaped.

In an embodiment, the first box thread flank and/or the second box thread flank are concave, convex, or straight shaped, and wherein the first pin thread flank and/or the second pin thread flank are concave, convex, or straight shaped.

In an embodiment, the box thread root is circular, square, triangular or trapezoidal shaped, and wherein the pin thread root is circular, square, triangular or trapezoidal shaped.

In an embodiment, the box included angle is from about 29 degrees to about 90 degrees, and the pin included angle is from about 29 degrees to about 90 degrees. In an embodiment, the box thread form is triangular and the box included angle is about 60 degrees, and the pin thread form is triangular shaped and the pin included angle is about 60 degrees.

In an embodiment, the box threads and/or the pin threads are treated by one or more of cold rolling, shot peening, phosphating, fluoropolymer coating, ceramic coating, chrome plating, anodizing, and variations thereof. In an embodiment, the box threads and/or the pin threads are treated by one or more of cold rolling, shot peening, fluoropolymer coating, and anodizing.

In an embodiment, the rotary shoulder connection further comprises one or more of a box boreback, a box stress relief groove and a pin stress relief groove.

In an embodiment, the rotary shoulder connection is made from one or more of low alloy steels, stainless steels, super alloys, titanium alloys, copper alloys, cobalt alloys, aluminum alloys, and variations thereof. In an embodiment, the rotary shoulder connection is made from one or more of low alloy steels, stainless steels, and variations thereof.

In an embodiment, the rotary shoulder connection is applied to one or more of drill pipe, heavy weight drill pipe, drill collars, pup joints, crossover subs, saver subs, bit subs, float subs, pump-in subs, inside blowout preventers, top drive shafts, top drive valves, safety valves, kelly valves, hoisting equipment, swivels, fishing tools, mud motors, rotary steerable tools, drill bits, directional drilling bottom hole assembly components, measurement while drilling components, logging while drilling components, well cleanout tools, completion tools, and variations thereof.

In an embodiment, the rotary shoulder connection is applied to one or more of drill pipe, heavy weight drill pipe, drill collars, pup joints, and variations thereof.

In an embodiment, a method of using a rotary shoulder connection comprises: providing the rotary shoulder connection; and applying the rotary shoulder connection to one or more products. In an embodiment, the rotary shoulder connection may be the improved double shoulder connection with a curved primary shoulder or the improved single-shoulder connection with a curved primary shoulder, as discussed above.

In an embodiment, the method further comprises tightening the rotary shoulder connection between one of more products to form the first seal.

In an embodiment, the method further comprises tightening the rotary shoulder connection between the one or more products to form the first seal and the torque shoulder.

In an embodiment, a method for determining a primary shoulder location comprises: locating a pitch line parallel to a connection box/pin taper; locating a first intersection of a pitch diameter and the pitch line; locating a first perpendicular to the connection box/pin axis at the first intersection; locating a second perpendicular to the connection box/pin axis at a first distance towards a primary box/pin shoulder from the first perpendicular; locating a first reference plane, and, optionally, locating a second intersection of the pitch line and the second perpendicular; and selecting a primary axial box/pin radius height, selecting a primary box/pin radius, and locating a primary box/pin center point between a box counter bore diameter and a pin bevel diameter.

In an embodiment, the method for determining a primary shoulder location further comprises step (g) defining a primary box/pin curved profile with respect to primary axial box/pin radius height, the primary box/pin center point and the primary box/pin radius, and, optionally, defining a primary box/pin angle with respect to the second perpendicular at the second intersection.

In an embodiment, the method for determining a primary shoulder location further comprises step (f) defining a primary box/pin angle with respect to the second perpendicular at the second intersection.

In an embodiment, the first distance is from about 0.5 inch to about 2.50 inches. In an embodiment, the first distance is from about 0.625 inch to about 2.250 inches. In an embodiment, the first distance is about 0.625 inch.

In an embodiment, a method for determining a secondary shoulder connection location comprises: locating a pitch line parallel to a connection box/pin taper; locating a first intersection of a pitch diameter and the pitch line; locating a first perpendicular to the connection box/pin axis at the first intersection; locating a second perpendicular to the connection box/pin axis at a first distance towards a primary box/pin shoulder from the first perpendicular; locating a first reference plane, and, optionally, locating a second intersection of the pitch line and the second perpendicular; locating a third perpendicular to the connection box/pin axis at a second distance toward a secondary box/pin shoulder; locating a second reference plane, and, optionally, locating a third intersection of a pin nose outer diameter and the third perpendicular; and selecting a secondary axial box/pin radius height, selecting a secondary box/pin radius, and locating a secondary box/pin center point between a pin nose outer diameter and a pin nose inner diameter.

In an embodiment, a method for determining a secondary shoulder connection location further comprises defining a secondary box/pin curved profile with respect to secondary axial box/pin radius height, the secondary box/pin center point and the secondary box/pin radius, and, optionally, defining a secondary box/pin angle with respect to the third perpendicular at the third intersection.

In an embodiment, a method for determining a secondary shoulder connection location further comprises optionally, defining a primary box/pin angle with respect to the second perpendicular at the second intersection.

In an embodiment, a method for determining a secondary shoulder connection location further comprises optionally, defining a secondary box/pin angle with respect to the third perpendicular at the third intersection.

In an embodiment, the second distance is from about 1 inch to about 8 inches. In an embodiment, the second distance is from about 2 inches to about 8 inches. In an embodiment, the second distance is a connection length.

These and other objects, features and advantages will become apparent as reference is made to the following detailed description, preferred embodiments, and examples, given for the purpose of disclosure, and taken in conjunction with the accompanying drawings and appended claims.

### BRIEF DESCRIPTION OF THE DRAWINGS

For a further understanding of the nature and objects of the present invention, reference should be made to the following detailed disclosure, taken in conjunction with the accompanying drawings, in which like parts are given like reference numerals, and wherein:

FIG. 1A illustrates a partial cross-sectional view of a double-shoulder connection with a pin and box made-up (screwed together), showing box connection features;

FIG. 1B illustrates the double-shoulder connection of FIG. 1A, showing pin connection features;

FIG. 2A illustrates a cross-sectional view of a standard (typical) double-shoulder connection, showing a standard primary shoulder connection and a standard secondary shoulder connection;

FIG. 2B illustrates a detailed view C1 in FIG. 2A, showing the standard primary shoulder connection;

FIG. 2C illustrates a detailed view C2 in FIG. 2A, showing the standard secondary shoulder connection;

FIG. 3A illustrates a cross-sectional view of the standard (typical) double shoulder connection shown in FIG. 2A, showing an exaggerated deformation of the box connection and the pin connection for clarity purposes;

FIG. 3B illustrates a detailed view D in FIG. 3A, showing a thread misalignment;

FIG. 4A illustrates a cross-sectional view of an improved double-shoulder connection with a curved primary shoulder and a standard secondary shoulder according to an embodiment of the present invention;

FIG. 4B illustrates a detailed view E in FIG. 4A, showing the curved primary shoulder according to an embodiment of the present invention;

FIG. 5A illustrates a cross-sectional view of the improved double-shoulder connection of FIG. 4A, showing box radial retaining forces and pin radial retaining forces;

FIG. 5B illustrates a detailed view F in FIG. 5A, showing improved thread alignment;

FIG. 6A illustrates a cross-sectional view of an improved double-shoulder connection with a standard primary shoulder and a curved secondary shoulder according to an embodiment of the present invention, showing box radial retaining forces and pin radial retaining forces;

FIG. 6B illustrates a detailed view G in FIG. 6A, showing the curved secondary shoulder according to an embodiment of the present invention;

FIG. 7 illustrates a cross-sectional view of an improved double-shoulder connection with an a curved primary shoulder and a curved secondary shoulder according to an embodiment of the present invention;

FIG. 8A illustrates a cross-sectional view of an improved single-shoulder connection with a curved primary shoulder according to an embodiment of the present invention;

FIG. 8B illustrates a detailed view H in FIG. 8A, showing the curved primary shoulder according to an embodiment of the present invention;

FIG. 9 illustrates a cross-sectional view of an improved single-shoulder connection with box and pin stress relief grooves according to an embodiment of the present invention;

FIG. 10 illustrates a cross-sectional view of an improved single-shoulder connection with a box boreback and a pin stress relief groove according to an embodiment of the present invention;

FIG. 11 illustrates a cross-sectional detailed view of a thread form according to an embodiment of the present invention;

FIG. 12A illustrates a cross-sectional view of an improved double- or single-shoulder connection with a curved primary connection shoulder according to an embodiment of the present invention;

FIG. 12B-1 illustrates a detailed view of the double- or single-shoulder connection in FIG. 12A, showing the curved primary connection shoulder according to an embodiment of the present invention;

FIG. 12B-2 illustrates an enlarged detailed view of the double- or single-shoulder connection in FIG. 12B-1, showing the curved primary connection shoulder according to an embodiment of the present invention;

FIG. 12C illustrates a cross-sectional view of an improved double- or single shoulder connection with an angled primary connection shoulder according to an embodiment of the present invention;

FIG. 13 illustrates a flow chart of a method for determining a primary connection shoulder location according to an embodiment of the present invention;

FIG. 14A illustrates a cross-sectional view of an improved double-shoulder connection with a curved primary connection shoulder and a curved secondary connection shoulder according to an embodiment of the present invention;

FIG. 14B-1 illustrates a detailed view of the double-shoulder connection in FIG. 14A, showing the curved secondary connection shoulder according to an embodiment of the present invention;

FIG. 14B-2 illustrates an enlarged detailed view of the double-shoulder connection in FIG. 14B-1, showing the curved secondary connection shoulder according to an embodiment of the present invention;

FIG. 14C illustrates a cross-sectional view of an improved double-shoulder connection with a standard primary connection shoulder and an angled secondary connection shoulder according to an embodiment of the present inventions;

FIG. 15 illustrates a flow chart of a method for determining a secondary connection shoulder location according to an embodiment of the present inventions; and

FIG. 16 illustrates a flowchart of a method of using an improved double-shoulder connection with a curved primary connection shoulder or an improved single-shoulder connection with a curved primary connection shoulder according to an embodiment of the present invention.

### DETAILED DESCRIPTION OF EMBODIMENTS OF THE INVENTION

The following detailed description of various embodiments of the present invention references the accompanying drawings, which illustrate specific embodiments in which the invention can be practiced. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains. Therefore, the scope of the present invention is defined only by the appended claims, along with the full scope of equivalents to which such claims are entitled.

Double-Shoulder Connection with Box and Pin Made-Up

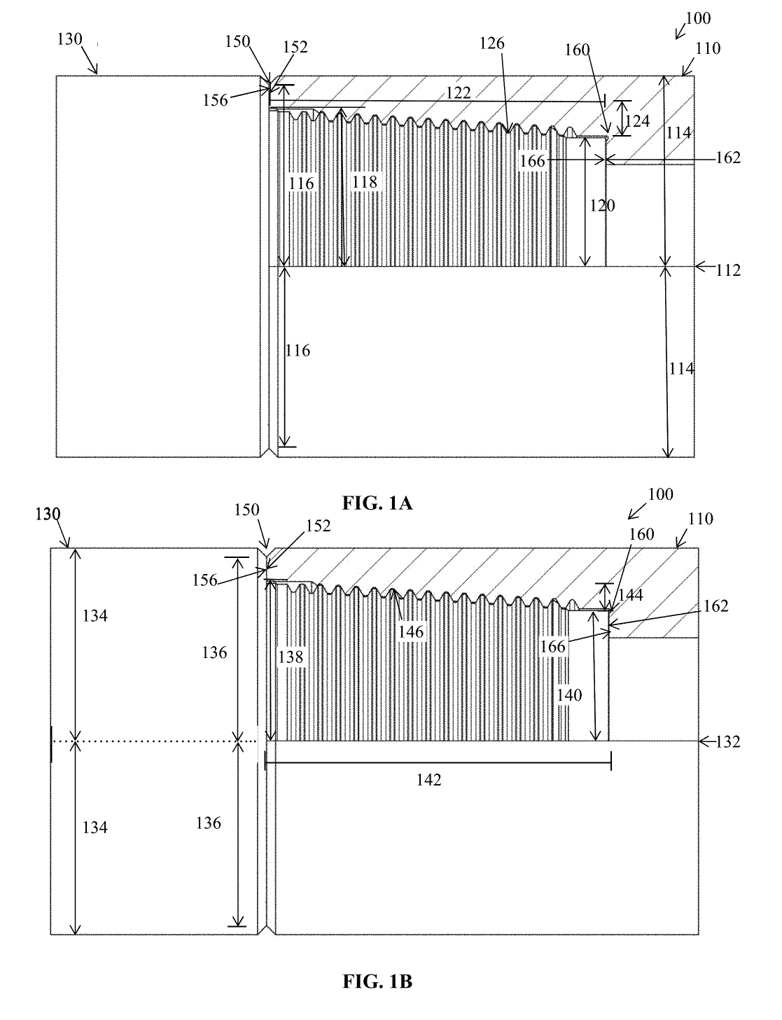

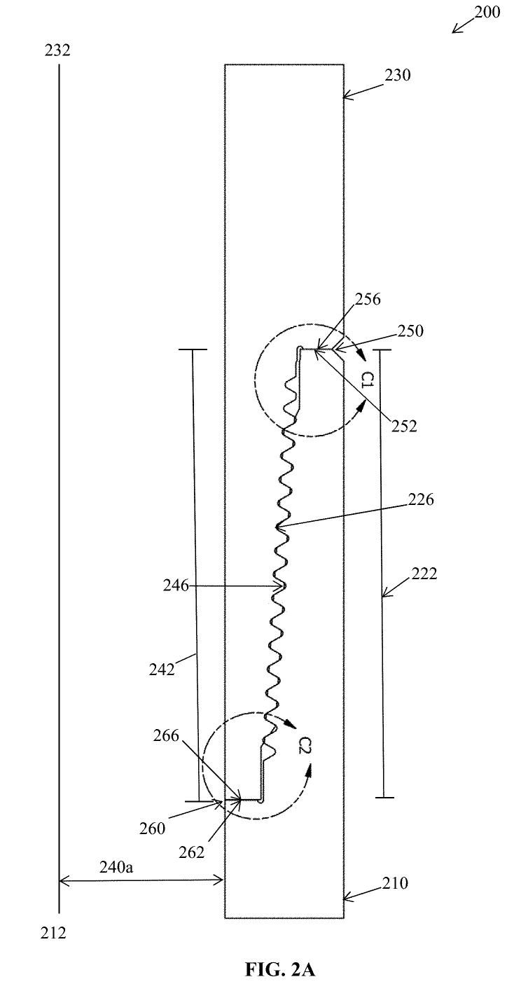

FIG. 1A illustrates a partial cross-sectional view of a double-shoulder connection 100 with a pin and box made-up (screwed together), showing box connection 110 features; and FIG. 1B illustrates the double-shoulder connection 100 of FIG. 1A, showing pin connection 130 features. As shown in FIGS. 1A and 1B, the double-shoulder connection 100 comprises a box connection 110 having a box axis (centerline) 112, a pin connection 130 having a pin axis (centerline) 132, a primary shoulder 150 and a secondary shoulder 160.

In an embodiment, the box connection 110 comprises a box axis (centerline) 112, a box outer radius 114, a box bevel radius 116, a box counter bore radius 118, a box inner radius 120, a box depth 122, a box taper 124 and box threads 126 cut along the box taper 124. The box connection 110 is a female, internally threaded half of the double-shoulder connection 100, similar to a nut. See FIGS. 1A & 1B.

In an embodiment, the pin connection 130 comprises a pin axis (centerline) 132, a pin outer radius 134, a pin bevel radius 136, a pin cylinder radius 138, a pin nose radius 140, a pin length 142, a pin taper 144 and pin threads 146 cut along the pin taper 144. The pin connection 130 is a male, externally threaded half of the double-shoulder connection 100, similar to a bolt. See FIGS. 1A & 1B.

In an embodiment, any suitable connection box/pin taper 124, 144 may be used for the box/pin connection 400, 500, 600, 700, 800, 900, 1000, 1200, 1400. For example, suitable connection box/pin taper 124, 144 may be from about ¾ inch per foot to about 3 inches per foot, and any range or value there between.

In an embodiment, any suitable thread pitch may be used for the box threads 426, 526, 626, 726, 826, 926, 1026, 1226, 1446 and/or pin threads 446, 546, 646, 746, 847, 946, 1046, 1246, 1446. For example, suitable thread pitches may be from about 3 threads per inch to about 5 threads per inch, and any range or value there between.

In an embodiment, any suitable thread form 1100 may be used for the box threads 426, 526, 626, 726, 826, 926, 1026, 1226, 1426 and/or pin threads 446, 546, 646, 746, 847, 946, 1046, 1246, 1446. Suitable thread forms 1100 may have various crest 1110, 1112, flank 1130, 1140 and root 1160 shapes with an included angle 1150 from about 29 degrees to about 90 degrees, and any range or value there between, as discussed below.

### Standard (Typical) Double Shoulder Connections

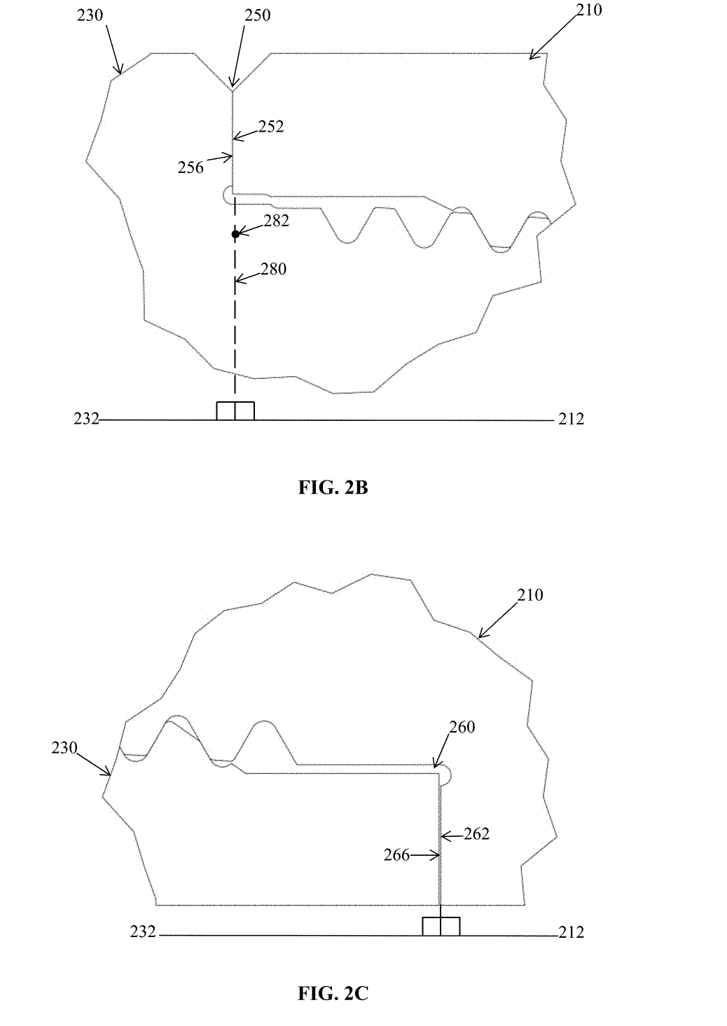

FIG. 2A illustrates a cross-sectional view of a standard (typical) double-shoulder 200 connection, showing a standard primary shoulder connection 250 and a standard secondary shoulder connection 260. As shown in FIG. 2A, the standard (typical) double-shoulder connection 200 comprises a box connection 210 having a box axis 112, a pin connection 230 having a pin axis 132, a primary shoulder 250 and a secondary shoulder 260.

The primary shoulder 250 comprises a primary box shoulder 252 at a primary box angle with respect to a first perpendicular 280 to the box axis 112 at a first end point 282 of the box connection; and a primary pin shoulder 256 at a primary pin angle with respect to the first perpendicular 280 to the pin axis 132 at the first end point 282 of the pin connection. See also FIG. 1A: 112 & FIG. 1B: 132 (showing box and pin made-up).

In a standard double-shoulder connection, the primary box angle is 0 degrees (i.e., primary box shoulder 252 is perpendicular to the box axis 112) and the primary pin angle is 0 degrees (i.e., primary pin shoulder 256 is perpendicular to the pin axis 132).

The secondary shoulder 260 comprises a secondary box shoulder 262 at a secondary box angle with respect to the box axis 112; and a secondary pin shoulder 266 at a secondary pin angle with respect to the pin axis 132. See also FIG. 1A: 112 & FIG. 1B: 132 (showing box and pin made-up).

In a standard double-shoulder connection, the secondary box angle is 0 degrees (i.e., secondary box shoulder 262 is perpendicular to the box axis 112) and the secondary pin angle is 0 degrees (i.e., secondary pin shoulder 266 is perpendicular to the pin axis 132).

FIG. 2B illustrates a detailed view C1 in FIG. 2A, showing the standard primary shoulder connection. As shown in FIG. 2B, the primary box angle is 0 degrees and the primary pin angle is 0 degrees.

FIG. 2C illustrates a detailed view C2 in FIG. 2A, showing the standard secondary shoulder connection. As shown in FIG. 2C, the secondary box angle is 0 degrees and the secondary pin angle is 0 degrees.

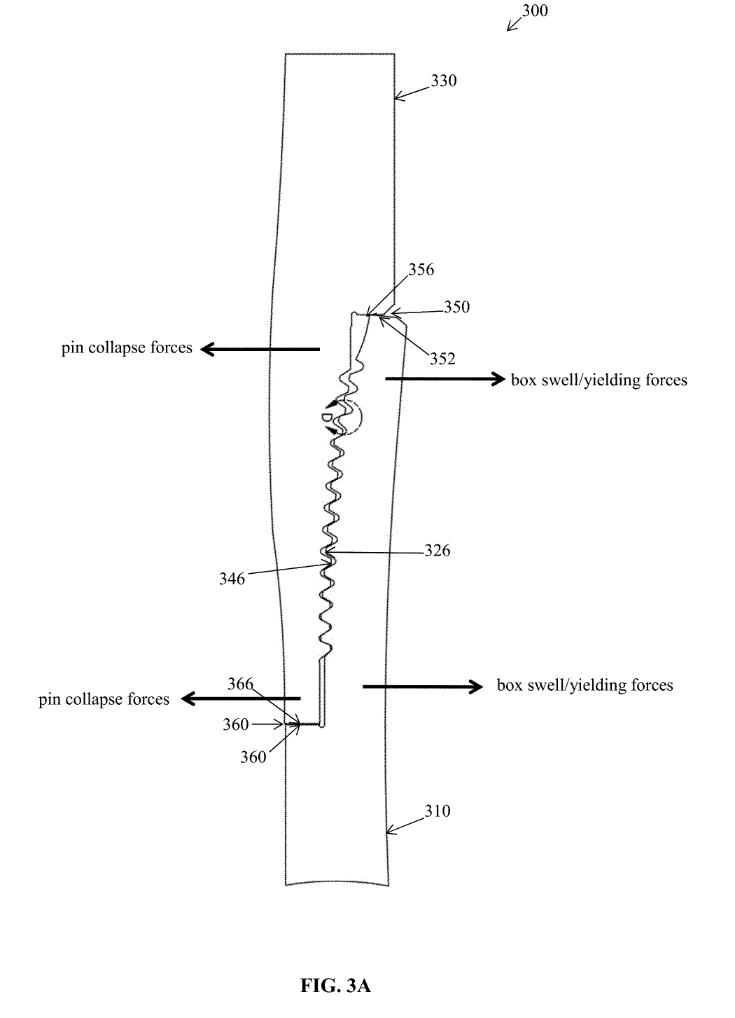

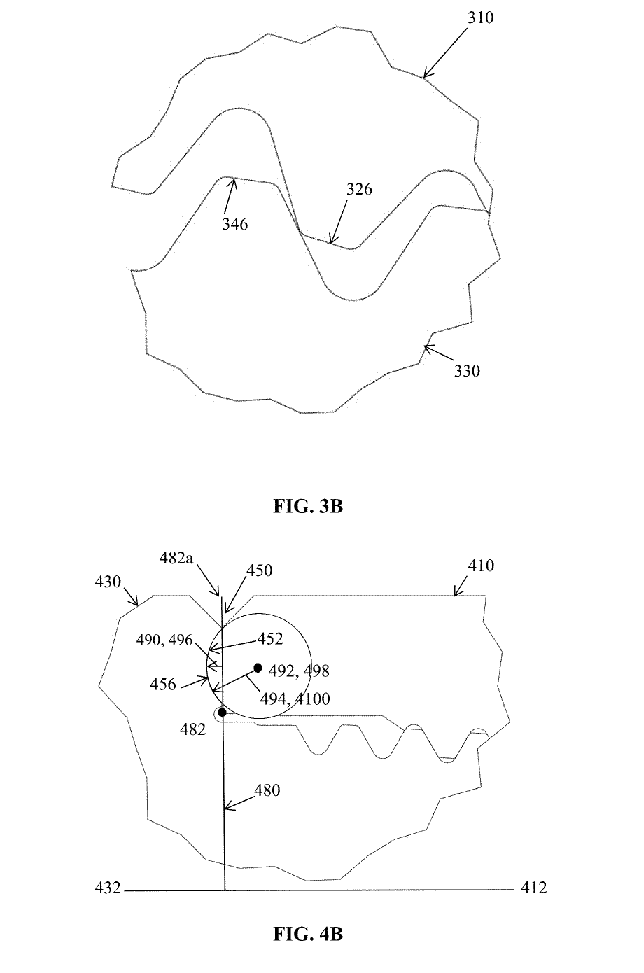

As discussed in the “Background of the Invention” section, standard (typical) double-shoulder connections 300 and standard (typical) single-shoulder connections suffer from the problem of box “swell” (e.g., box material yields) due to tapered threads, included thread profile angle (see FIG. 11: 1150) and high generated axial compressive loads. FIG. 3A illustrates a cross-sectional view of the standard (typical) double-shoulder connection 200, 300 shown in FIG. 2A, showing an exaggerated deformation of the box connection 210, 310 and the pin connection 230, 330 for clarity purposes.

Standard (typical) double-shoulder connections 200, 300 and standard (typical) single-shoulder connections suffer from the problem of box swell (e.g., box material yields). As shown in FIG. 3A, the box swell/yielding forces force the primary shoulder 350 of the box connection 310 outward such that the box connection 210, 310 swells (e.g., the box material yields), causing deformation of and/or permanent damage to the box connection 210, 310.

Standard (typical) double-shoulder connections 200, 300 and standard (typical) single-shoulder connections also suffer from the problem of pin collapse. As shown in FIG. 3A, the pin collapse forces push a portion of the pin nose inward, causing deformation of and/or permanent damage to the pin connection 230, 330.

Further, the cyclic box swell/yielding forces are transmitted into, for example, a first pin thread and a second pin thread resulting in damage to the first pin thread and the second pin thread (i.e., initially causing cracks at the root of the pin threads and, ultimately, failure of the pin threads). This combination of box swell (e.g., box material yields) and pin collapse can lead to misalignment of the box threads 226, 326 and the pin threads 246, 346, as well as permanent damage to the box connection 210, 310 and/or the pin connection 230, 330. FIG. 3B illustrates a detailed view D in FIG. 3A, showing a thread misalignment. As shown in FIG. 3B, the box threads 226, 326 are misaligned with the pin threads 246, 346, causing damage to the box threads 226, 326 and/or the pin threads 246, 346.

In addition, this combination of box swell and pin collapse, in conjunction with high alternating axial, torsional, and bending loads, can lead to premature fatigue failure (e.g., material yields) of the standard (typical) double-shoulder connection 200, 300 and the standard (typical) single-shoulder connection, damage to the box threads 226, 326 and/or the pin threads 246, 346, and permanent deformation of the box connection 210, 310 and/or the pin connection 230, 330.

### Improved Double-Shoulder Connections

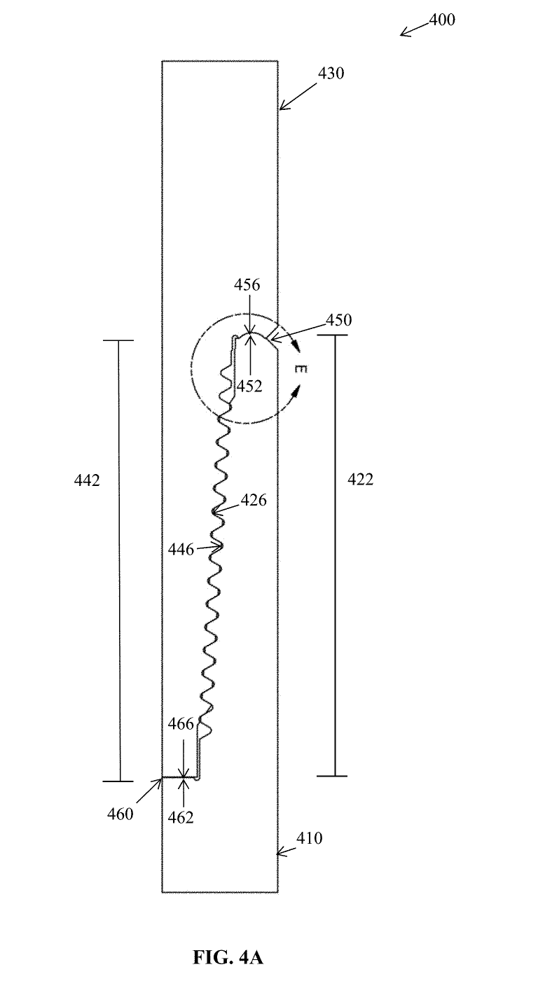

A curved primary shoulder 450 reduces box swell (e.g., box material yields) and provides better alignment of the box threads 426 and pin threads 446 in an improved double-shoulder connection 400. The curved primary shoulder 450 provides an avenue for compressive forces and elevated torques while drilling to move axially and inward into the pin connection, reducing box swell. The curved primary shoulder 450 also balances compressive forces between the primary and secondary shoulder connections. FIG. 4A illustrates a cross-sectional view of an improved double-shoulder connection 400 with a curved primary shoulder 450 and a standard secondary shoulder 460 according to an embodiment of the present invention. As shown in FIG. 4A, the improved double-shoulder connection 400 comprises a box connection 410 having a box axis (centerline) 412, a pin connection 430 having a pin axis (centerline) 432, a primary shoulder 450, and a secondary shoulder 460.

In an embodiment, the primary shoulder 450 comprises a primary box shoulder 452; and a primary pin shoulder 456. See also FIG. 1A: 112 & FIG. 1B: 132 (showing box and pin made-up).

### Primary Box Shoulder

In an embodiment, the primary box shoulder 452 may be any suitable shape. For example, suitable shapes include, but are not limited to, concave shaped, conical shaped, convex shaped, cylindrical shaped, conical-cylindrical shaped, and variations thereof. In an embodiment, the primary shoulder 452 may be convex shaped.

In an embodiment, the primary box shoulder 452 may be any suitable profile. For example, suitable profiles include, but are not limited to, angled profiles, curved profiles and variations thereof. In an embodiment, the primary box shoulder 452 may be an angled profile defined by a primary box angle with respect to a first perpendicular 480 to the box axis 412 at a first end point 482 of the box connection, as discussed below. In an embodiment, the first end point 482 may be equal to a datum intersection, as discussed below.

In an embodiment, the primary box angle may be from greater than or equal to about 0 degrees to less than or equal to about 15 degrees, and any range or value there between. In an embodiment, the primary box angle may be from greater than or equal to about 0 degrees to less than or equal to about 10 degrees. In an embodiment, the primary box angle may be about 5 degrees. In an embodiment, the primary box angle may be about 0 degrees.

In an embodiment, the primary box shoulder 452 may be a curved profile defined by a primary axial box radius height 490, a primary box center point 492 and a primary box radius 494, as discussed below.

In an embodiment, the primary axial box radius height 490 may be from about 0.000 inch to about the length of the primary box radius 494 in inches, and any range or value there between.

In an embodiment, the primary box center point 492 may be located between a box counter bore diameter (i.e., two time a box counter bore radius 118) and a pin bevel diameter (i.e., two times a pin bevel radius 136). In an embodiment, the primary box center point 492 may be about half-way between the box counter bore diameter (i.e., two time a box counter bore radius 118) and the pin bevel diameter (i.e., two times a pin bevel radius 136). In an embodiment, the primary box center point 492 may be about [(box counter bore diameter (i.e., two times a box counter bore radius 118)+pin bevel diameter (i.e., two times a pin bevel radius 136))/2].

In an embodiment, the primary box radius 494 may be greater than about [(pin bevel diameter (i.e., two times pin bevel radius 136)−box counter bore diameter (i.e., two times box counter bore radius 118))/4] inches, and any range or value there between.

In an embodiment, the primary box radius 494 may be greater than about [(pin bevel diameter (i.e., two times pin bevel radius 136)−box counter bore diameter (i.e., two times box counter bore radius 118))/4] inches, and any range or value there between.

### Primary Pin Shoulder

In an embodiment, the primary pin shoulder 456 may be any suitable shape. For example, suitable shapes include, but are not limited to, concave shaped, conical shaped, convex shaped, cylindrical shaped, conical-cylindrical shaped, and variations thereof. In an embodiment, the primary pin shoulder 456 may be concave shaped.

In an embodiment, the primary pin shoulder 456 may be any suitable profile. For example, suitable profiles include, but are not limited to, angled profiles, curved profiles, and variations thereof. In an embodiment, the primary pin shoulder 456 may be an angled profile defined by a primary pin angle with respect to a first perpendicular 480 to the pin axis 432 at the first end point 482 of the pin connection, as discussed below. In an embodiment, the first end point 482 may be equal to a datum intersection.

In an embodiment, the primary pin angle may be from greater than or equal to about 0 degrees to less than or equal to about 15 degrees, and any range or value there between. In an embodiment, the primary pin angle may be from greater than or equal to about 0 degrees to less than or equal to about 10 degrees. In an embodiment, the primary pin angle may be about 5 degrees. In an embodiment, the primary pin angle may be about 0 degrees.

In an embodiment, the primary pin shoulder 456 may be a curved profile defined by a primary axial pin radius height 496, a primary pin center point 498 and a primary pin radius 4100, as discussed below.

In an embodiment, the primary axial pin radius height 496 may be from about 0.000 inch to about the length of the primary pin radius 4100 in inches, and any range or value there between.

In an embodiment, the primary axial box radius height 490 may be about equal to the primary axial pin radius height 496.

In an embodiment, the primary pin center point 498 may be located between a box counter bore diameter (i.e., two time a box counter bore radius 118) and a pin bevel diameter (i.e., two times a pin bevel radius 136). In an embodiment, the primary pin center point 498 may be about half-way between the box counter bore diameter (i.e., two times a box counter bore radius 118) and the pin bevel diameter (i.e., two times a pin bevel radius 136). In an embodiment, the primary pin center point 498 may be about [(box counter bore diameter (i.e., two times a box counter bore radius 118)+pin bevel diameter (i.e., two times a pin bevel radius 136))/2].

In an embodiment, the primary box center point 492 may be about equal to the primary pin center point 498.

In an embodiment, the primary pin radius 4100 may be greater than about [(pin bevel diameter (i.e., two times pin bevel radius 136)−box counter bore diameter (i.e., two times box counter bore radius 118))/4 inches, and any range or value there between.

In an embodiment, the primary pin radius 4100 may be greater than about [(pin bevel diameter (i.e., two times pin bevel radius 136)−box counter bore diameter (i.e., two times box counter bore radius 118))/4 inches, and any range or value there between.

In an embodiment, the primary box angle may be about equal to the primary pin angle to form a first seal. In an embodiment, the primary box angle may be slightly different from the primary pin angle to form a first seal. In an embodiment, the first seal may be a gas-tight seal.

In an embodiment, the primary box radius 494 may be about equal to the primary pin radius 4100 to form a first seal. In an embodiment, the primary box radius 494 may be slightly different from the primary pin radius 4100 to form a first seal. In an embodiment, the first seal may be a gas-tight seal.

FIG. 4B illustrates a detailed view E in FIG. 4A, showing the curved primary shoulder 450 according to an embodiment of the present invention. As shown in FIG. 4B, the primary box radius 494 and the primary pin radius 4100 may be greater than about [(pin bevel diameter (i.e., two times pin bevel radius 136)−box counter bore diameter (i.e., two times box counter bore radius 118))/4] inches. See also FIG. 2B (showing a standard primary shoulder 250).

In an embodiment, the secondary shoulder 460 comprises a secondary box shoulder 462; and a secondary pin shoulder 466. See also FIG. 1A: 112 & FIG. 1B: 132 (showing box and pin made-up).

### Secondary Box Shoulder

In an embodiment, the secondary box shoulder 462 may be any suitable shape. For example, suitable shapes include, but are not limited to, concave shaped, conical shaped, convex shaped, cylindrical shaped, conical-cylindrical shaped, and variations thereof. In an embodiment, the secondary box shoulder 462 may be conical shaped (outside of cone, male).

In an embodiment, the secondary box shoulder 462 may be any suitable profile. For example, suitable profiles include, but are not limited to, angled profiles, curved profiles and variations thereof. In an embodiment, the secondary box shoulder 462 may be an angled profile defined by a secondary box angle with respect to a second perpendicular to the box axis 412 at a second end point of the box connection, as discussed below.

In an embodiment, the secondary box angle may be from greater than or equal to about 0 degrees to less than or equal to about 15 degrees, and any range or value there between. In an embodiment, the secondary box angle may be from greater than or equal to about 0 degrees to less than or equal to 10 degrees. In an embodiment, the secondary box angle may be about 5 degrees. In an embodiment, the secondary box angle may be about 0 degrees.

In a standard secondary shoulder 460, the secondary box angle is 0 degrees (i.e., secondary box shoulder 462 is perpendicular to the box axis 412).

In an embodiment, the secondary box shoulder 462 may be a curved profile defined by a secondary axial box radius height, a secondary box center point and a secondary box radius, as discussed below.

In an embodiment, the secondary axial box radius height may be from about 0.000 inch to about the length of the secondary box radius in inches, and any range or value there between.

In an embodiment, the secondary box center point may be located between a pin nose outer diameter (i.e., two times pin nose radius 140) and a pin nose inner diameter (i.e., two time pin nose inner radius 240a), and any range or value there between. In an embodiment, the secondary box center point may be located about half-way between the pin nose outer diameter (i.e., two times pin nose radius 140) and the pin nose inner diameter (i.e., two times pin nose inner radius 240a). In an embodiment, the secondary box center point may be about [(pin nose outer diameter (i.e., two times pin nose radius 140)+pin nose inner diameter (i.e., two times pin nose inner radius 240a))/2].

In an embodiment, the secondary box radius may be greater than about [(pin nose outer diameter (i.e., two times pin nose radius 140)−pin nose inner diameter (i.e., two times pin nose inner radius 240a))/4] inches, and any range or value there between.

### Secondary Pin Shoulder

In an embodiment, the secondary pin shoulder 466 may be any suitable shape. For example, suitable shapes include, but are not limited to, concave shaped, conical shaped, convex shaped, cylindrical shaped, conical-cylindrical shaped, and variations thereof. In an embodiment, the secondary pin shoulder 466 may be conical shaped (inside of cone, female).

In an embodiment, the secondary pin shoulder 466 may be any suitable profile. For example, suitable profiles include, but are not limited to, angled profiles, curved profiles and variations thereof. In an embodiment, the secondary pin shoulder 466 may be an angled profile defined by a secondary pin angle with respect to the second perpendicular to the pin axis 432 at the second end point of the pin connection, as discussed below.

In an embodiment, the secondary pin angle may be from greater than or equal to about 0 degrees to less than or equal to about 15 degrees, and any range or value there between. In an embodiment, the secondary pin angle may be from greater than or equal to about 0 degrees to less than or equal to about 10 degrees. In an embodiment, the secondary pin angle may be about 5 degrees. In an embodiment, the secondary pin angle may be about 0 degrees.

In a standard secondary shoulder 460, the secondary pin angle is 0 degrees (i.e., secondary pin shoulder 466 is perpendicular to the pin axis 432).

In an embodiment, the secondary pin shoulder 466 may be a curved profile defined by a secondary axial pin radius height, a secondary pin center point and a secondary pin radius, as discussed below.

In an embodiment, the secondary axial pin radius height may be from about 0.000 inch to about the length of the secondary pin radius in inches, and any range or value there between.

In an embodiment, the secondary axial box radius height may be about equal to the secondary axial pin radius height.

In an embodiment, the secondary pin center point may be located between a pin nose outer diameter (i.e., two times pin nose radius 140) and a pin nose inner diameter (i.e., two times pin nose inner radius 240a), and any range or value there between. In an embodiment, the secondary pin center point may be located about half-way between the pin nose outer diameter (i.e., two times pin nose radius 140) and the pin nose inner diameter (i.e., two times pin nose inner radius 240a). In an embodiment, the secondary pin center point may be about [(pin nose outer diameter (i.e., two times pin nose radius 140)+pin nose inner diameter (i.e., two times pin nose inner radius 240a))/2].

In an embodiment, the secondary box center point may be about equal to the secondary pin center point.

In an embodiment, the secondary pin radius may be greater than about [(pin nose outer diameter (i.e., two times pin nose radius 140)−pin nose inner diameter (i.e., two times pin nose inner radius 240a))/4] inches, and any range or value there between.

In an embodiment, the secondary box angle may be about equal to the secondary pin angle to form a torque shoulder.

In an embodiment, the secondary box angle may be slightly different from the secondary pin angle to form a torque shoulder that is a second seal. In an embodiment, the torque shoulder or the second seal may be a gas-tight seal.

In an embodiment, the secondary box radius may be about equal to the secondary pin radius to form a torque shoulder.

In an embodiment, the secondary box radius may be slightly different from the secondary pin radius to form a torque shoulder that is a second seal. In an embodiment, the torque shoulder or the second seal may be a gas-tight seal.

FIG. 4A illustrates the standard secondary shoulder 460 according to an embodiment of the present invention. As shown in FIG. 4A, the secondary box angle is 0 degrees; and the secondary pin angle is 0 degrees. See also FIG. 2C (showing a standard secondary shoulder).

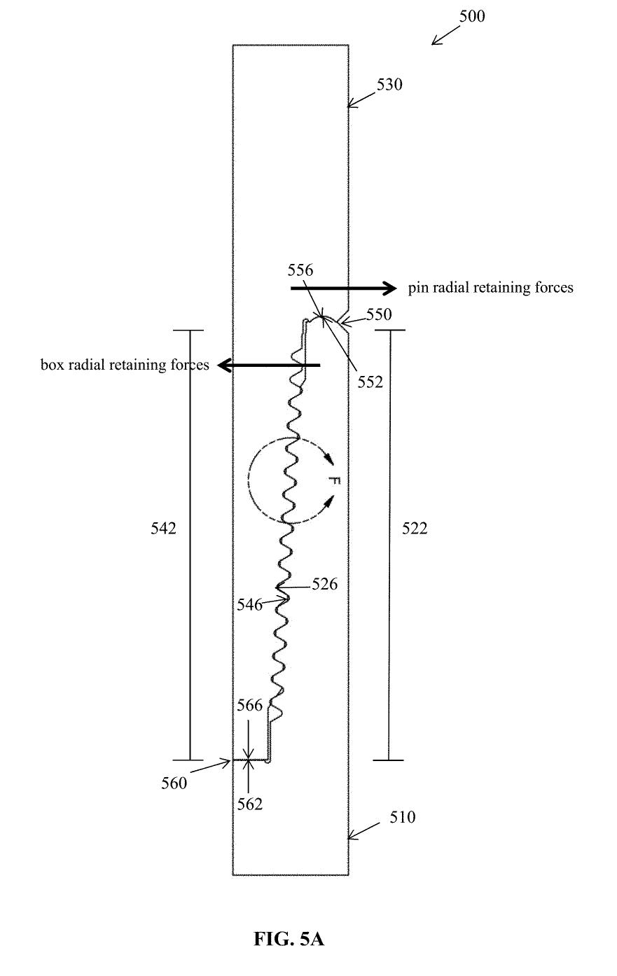

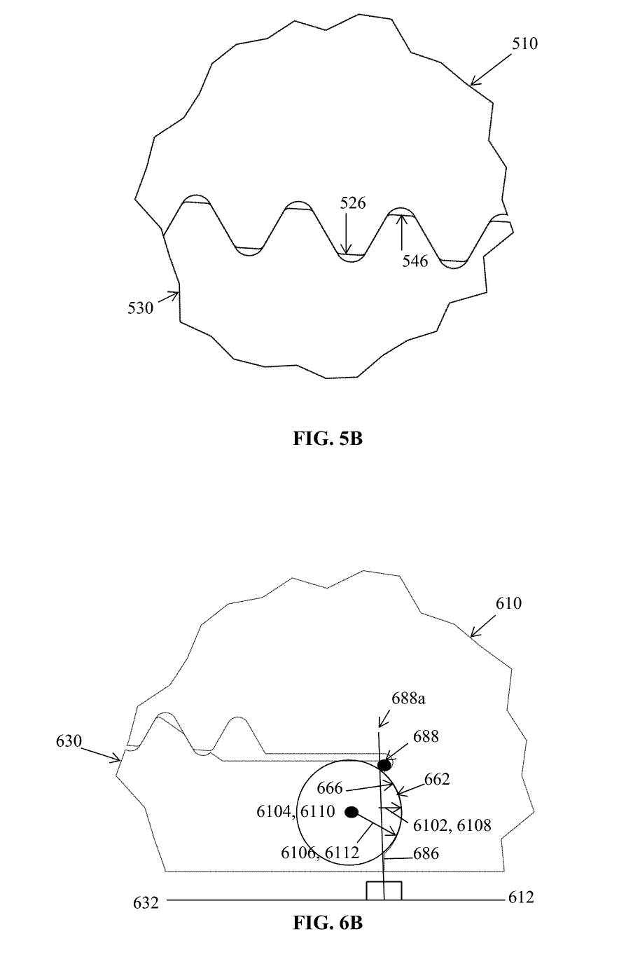

As discussed above, a curved primary shoulder 450, 550 reduces box swell (e.g., box material yields) and provides better alignment of the box threads 426, 526 and pin threads 446, 546 in an improved double-shoulder connection 400, 500. The curved primary shoulder 450, 550 provides an avenue for compressive forces and elevated torques while drilling to move axially and radially (i.e., inward) into the pin connection, reducing box swell (e.g., box material yields). The curved primary shoulder 450, 550 also balances compressive forces between the primary and secondary shoulder connections. FIG. 5A illustrates a cross-sectional view of the improved double-shoulder connection 400, 500 of FIG. 4A, showing box radial retaining forces and pin radial retaining forces. As shown in FIG. 5A, the curved primary shoulder 450, 550 reduces the box swell/yielding forces shown in FIG. 3A. See also FIG. 3A (showing a primary shoulder 350). In other words, the box radial retaining forces generated by the curved primary shoulder 450, 550 reduce box swell/yielding forces, reducing box swell (e.g., box material yields).

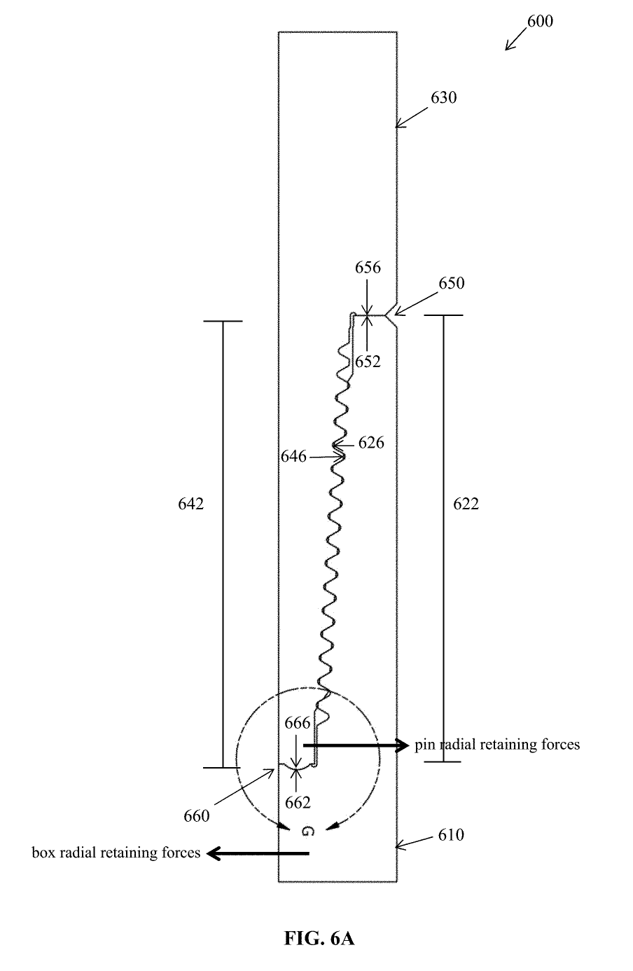

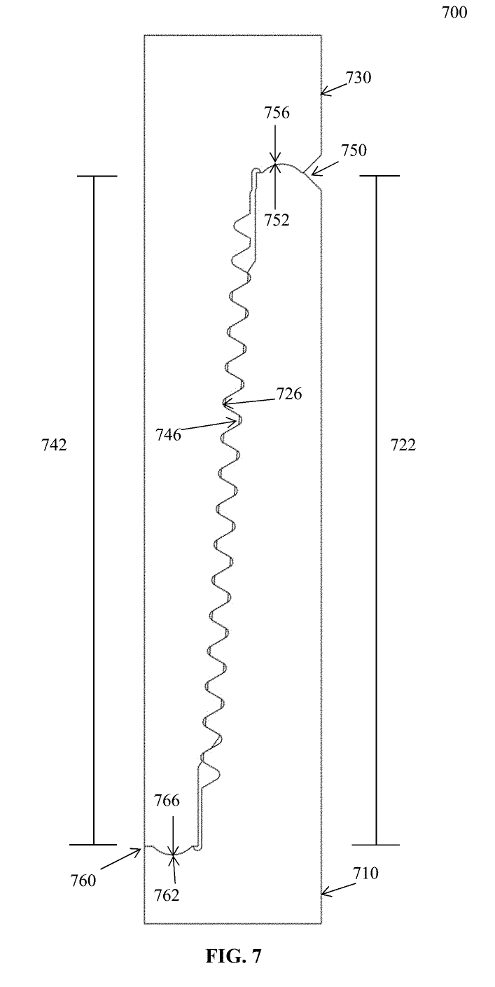

FIG. 6A illustrates a cross-sectional view of an improved double-shoulder connection 600 with a standard primary shoulder 650 and a curved secondary shoulder 660 according to an embodiment of the present invention; and FIG. 7 illustrates a cross-sectional view of an improved double-shoulder connection with a curved primary shoulder and a curved secondary shoulder according to an embodiment of the present invention. As shown in FIGS. 6A and 7, the improved double-shoulder connection 600, 700 comprises a box connection 610, 710 having a box axis (centerline) 612, a pin connection 630, 730 having a pin axis (centerline) 632, a primary shoulder 650, 750, and a secondary shoulder 660, 760.

In an embodiment, the primary shoulder 650, 750 comprises a primary box shoulder 652, 752; and a primary pin shoulder 656, 756. See also FIG. 1A: 112 & FIG. 1B: 132 (showing box and pin made-up).

### Primary Box Shoulder

In an embodiment, the primary box shoulder 652, 752 may be any suitable shape. For example, suitable shapes include, but are not limited to, concave shaped, conical shaped, convex shaped, cylindrical shaped, conical-cylindrical shaped, and variations thereof. In an embodiment, the primary box shoulder 652 may be conical shaped (outside of cone, male). In an embodiment, the primary box shoulder 752 may be convex shaped.

In an embodiment, the primary box shoulder 652, 752 may be any suitable profile. For example, suitable profiles include, but are not limited to, angled profiles, curved profiles, and variations thereof. In an embodiment, the primary box shoulder 652 may be an angled profile defined by a primary box angle with respect to a first perpendicular to the box axis 612 at a first end point of the box connection, as discussed below. In an embodiment, the first end point may be equal to a datum intersection.

In an embodiment, the primary box angle may be from greater than or equal to about 0 degrees to less than or equal to about 15 degrees, and any range or value there between. In an embodiment, the primary box angle may be from greater than or equal to about 0 degrees to less than or equal to about 10 degrees. In an embodiment, the primary box angle may be about 5 degrees. In an embodiment, the primary box angle may be about 0 degrees.

In an embodiment, the primary box shoulder 752 may be a curved profile defined by a primary axial box radius height, a primary box center point and a primary box radius, as discussed below.

In an embodiment, the primary axial box radius height may be from about 0.000 inch to about the length of the primary box radius in inches, and any range or value there between.

In an embodiment, the primary box center point may be located between a box counter bore diameter (i.e., two times a box counter bore radius 118) and a pin bevel diameter (i.e., two times a pin bevel radius 136). In an embodiment, the primary box center point may be about half-way between the box counter bore diameter (i.e., two times a box counter bore radius 118) and the pin bevel diameter (i.e., two times a pin bevel radius 136). In an embodiment, the primary box center point may be about [(box counter bore diameter (i.e., two times a box counter bore radius 118)+pin bevel diameter (i.e., two times a pin bevel radius 136))/2].

In an embodiment, the primary box radius may be greater than about [(pin bevel diameter (i.e., two times pin bevel radius 136)−box counter bore diameter (i.e., two times box counter bore radius 118))/4] inches, and any range or value there between.

In an embodiment, the primary box radius may be greater than about [(pin bevel diameter (i.e., two times pin bevel radius 166)−box counter bore diameter (i.e., two times box counter bore radius 118))/4] inches, and any range or value there between.

### Primary Pin Shoulder

In an embodiment, the primary pin shoulder 656, 756 may be any suitable shape. For example, suitable shapes include, but are not limited to, concave shaped, conical shaped, convex shaped, cylindrical shaped, conical-cylindrical shaped, and variations thereof. In an embodiment, the primary pin shoulder 656 may be conical shaped (inside of cone, female). In an embodiment, the primary pin shoulder 765 may be concave shaped.

In an embodiment, the primary pin shoulder 656, 756 may be any suitable profile. For example, suitable profiles include, but are not limited to, angled profiles, curved profiles, and variations thereof. In an embodiment, the primary pin shoulder 656 may be an angled profile defined by a primary pin angle with respect to the first perpendicular to the pin axis 632 at the first end point of the pin connection, as discussed below. In an embodiment, the first end point may be equal to a datum intersection.

In an embodiment, the primary pin angle may be from greater than or equal to about 0 degrees to less than or equal to about 15 degrees, and any range or value there between. In an embodiment, the primary pin angle may be from greater than or equal to about 0 degrees to less than or equal to about 10 degrees. In an embodiment, the primary pin angle may be about 5 degrees. In an embodiment, the primary pin angle may be about 0 degrees.

In an embodiment, the primary pin shoulder 756 may be a curved profile defined by a primary axial pin radius height, a primary pin center point and a primary pin radius, as discussed below.

In an embodiment, the primary pin axial pin radius height may be from about 0.000 inch to about the length of the primary pin radius in inches, and any range or value there between.

In an embodiment, the primary axial box radius height may be about equal to the primary axial pin radius height.

In an embodiment, the primary pin center point may be located between a box counter bore diameter (i.e., two times a box counter bore radius 118) and a pin bevel diameter (i.e., two times a pin bevel radius 136). In an embodiment, the primary pin center point may be about half-way between the box counter bore diameter (i.e., two times a box counter bore radius 118) and the pin bevel diameter (i.e., two times a pin bevel radius 136). In an embodiment, the primary pin center point may be about [(box counter bore diameter (i.e., two times a box counter bore radius 118)+pin bevel diameter (i.e., two times a pin bevel radius 136))/2].

In an embodiment, the primary pin radius may be greater than about [(pin bevel diameter (i.e., two times pin bevel radius 136)−box counter bore diameter (i.e., two times box counter bore radius 118))/4] inches, and any range or value there between.

In an embodiment, the primary pin radius may be greater than about [(pin bevel diameter (i.e., two times pin bevel radius 136)−box counter bore diameter (i.e., two times box counter bore radius 118))/4] inches, and any range or value there between.

In an embodiment, the primary box angle may be about equal to the primary pin angle to form a first seal. In an embodiment, the primary box angle may be slightly different from the primary pin angle to form a first seal. In an embodiment, the first seal may be a gas-tight seal.

In an embodiment, the primary box center point may be about equal to the primary pin center point.

In an embodiment, the primary box radius may be about equal to the primary pin radius to form a first seal. In an embodiment, the primary box radius may be slightly different from the primary pin radius to form a first seal. In an embodiment, the first seal may be a gas-tight seal.

In an embodiment, the secondary shoulder 660, 760 comprises a secondary box shoulder 662, 762; and a secondary pin shoulder 666, 766. See also FIG. 1A: 112 & FIG. 1B: 132 (showing box and pin made-up).

### Secondary Box Shoulder

In an embodiment, the secondary box shoulder 662, 762 may be any suitable shape. For example, suitable shapes include, but are not limited to, concave shaped, conical shaped, convex shaped, cylindrical shaped, conical-cylindrical shaped, and variations thereof. In an embodiment, the secondary box shoulder 662, 762 may be concave shaped.

In an embodiment, the secondary box shoulder 662, 762 may be any suitable profile. For example, suitable profiles include, but are not limited to, angled profiles, curved profiles, and variations thereof. In an embodiment, the secondary box shoulder 662, 762 may be an angled profile defined by a secondary box angle with respect to a second perpendicular 686 to the box axis 612 at a second end point 688 of the box connection, as discussed below.

In an embodiment, the secondary box angle may be from greater than or equal to about 0 degrees to less than or equal to about 15 degrees, and any range or value there between. In an embodiment, the secondary box angle may be from greater than or equal to about 0 degrees to less than or equal to about 10 degrees. In an embodiment, the secondary box angle may be about 5 degrees. In an embodiment, the secondary box angle may be about 0 degrees.

In an embodiment, the secondary box shoulder 662, 762 may be a curved profile defined by a secondary box axial box radius height 6102, a secondary box center point 6104 and a secondary box radius 6106, as discussed below.

In an embodiment, the secondary axial box radius height 6102 may be from about 0.000 inch to about the length of the primary box radius 6106 in inches, and any range or value there between.

In an embodiment, the secondary box center point 6104 may be located between a pin nose outer diameter (i.e., two times pin nose radius 140) and a pin nose inner diameter (i.e., two times pin nose inner radius 240a), and any range or value there between. In an embodiment, the secondary box center point 6104 may be located about half-way between a pin nose outer diameter (i.e., two times pin nose radius 140) and a pin nose inner diameter (i.e., two times pin nose inner radius 240a). In an embodiment, the secondary box center point 6104 may be about [(pin nose outer diameter (i.e., two times pin nose radius 140)+pin nose inner diameter (i.e., two time pin nose inner radius 240a))/2].

In an embodiment, the secondary box radius 6106 may be greater than about [(pin nose outer diameter (i.e., two times pin nose radius 140)−pin nose inner diameter (i.e., two times pin nose inner radius 240a))/4] inches, and any range or value there between.

### Secondary Pin Shoulder

In an embodiment, the secondary pin shoulder 666, 766 may be any suitable shape. For example, suitable shapes include, but are not limited to, concave shaped, conical shaped, convex shaped, cylindrical shaped, conical-cylindrical shaped, and variations thereof. In an embodiment, the secondary pin shoulder 666, 766 may be convex shaped.

In an embodiment, the secondary pin shoulder 666, 766 may be any suitable profile. For example, suitable profiles include, but are not limited to, angled profiles, curved profiles, and variations thereof. In an embodiment, the secondary pin shoulder 666, 766 may be an angled profile defined by a secondary pin angle with respect to the second perpendicular 686 to the pin axis 632 at the second end point 688 of the pin connection, as discussed below.

In an embodiment, the secondary pin angle may be from greater than or equal to about 0 degrees to less than or equal to about 15 degrees, and any range or value there between. In an embodiment, the secondary pin angle may be from greater than or equal to about 0 degrees to less than or equal to about 10 degrees. In an embodiment, the secondary pin angle may be about 5 degrees. In an embodiment, the secondary pin angle may be about 0 degrees.

In an embodiment, the secondary pin shoulder 666, 766 may be a curved profile defined by a secondary axial pin radius height 6106, a secondary pin center point 6110 and a secondary pin radius 6112, as discussed below.

In an embodiment, the secondary axial pin radius height 6108 may be from about 0.000 inch to about the length of the secondary pin radius 6112 in inches, and any range or value there between.

In an embodiment, the secondary axial box radius height 6102 may be about equal to the secondary axial pin radius height 6108.

In an embodiment, the secondary pin center point 6110 may be located between a pin nose outer diameter (i.e., two times pin nose radius 140) and a pin nose inner diameter (i.e., two times pin nose inner radius 240a), and any range or value there between. In an embodiment, the secondary pin center point 6110 may be located about half-way between a pin nose outer diameter (i.e., two times pin nose radius 140) and a pin nose inner diameter (i.e., two times pin nose inner radius 240a). In an embodiment, the secondary pin center point 6110 may be about [(pin nose outer diameter (i.e., two times pin nose radius 140)+pin nose inner diameter (i.e., two times pin nose inner radius 240a))/2].

In an embodiment, the secondary pin radius 6112 may be greater than about [(pin nose outer diameter (i.e., two times pin nose radius 140)−pin nose inner diameter (i.e., two times pin nose inner radius 240a))/4] inches, and any range or value there between.

In an embodiment, the secondary box angle may be about equal to the secondary pin angle to form a torque shoulder.

In an embodiment, the secondary box angle may be slightly different from the secondary pin angle to form a torque shoulder that is a second seal. In an embodiment, the torque shoulder or the second seal may be a gas-tight seal.

In an embodiment, the secondary box center point 6104 may be about equal to the secondary pin center point 6110.

In an embodiment, the secondary box radius 6106 may be about equal to the secondary pin radius 6112 to form a torque shoulder.

In an embodiment, the secondary box radius 6106 may be slightly different from the secondary pin radius 6112 to form a torque shoulder that is a second seal. In an embodiment, the torque shoulder or the second seal may be a gas-tight seal.

FIG. 6B illustrates a detailed view G in FIG. 6A, showing the curved secondary shoulder 660 according to an embodiment of the present invention. As shown in FIG. 6B, the secondary box radius 6106 and the secondary pin radius 6112 may be greater than about [(pin nose outer diameter (i.e., two times pin nose radius 140)−pin nose inner diameter (i.e., two times pin nose inner radius 240a))/4] inches, and any range or value there between. See also FIG. 2C (showing a standard secondary shoulder 260).

As discussed above, a curved secondary shoulder 660 reduces box swell (e.g., box material yields) in an improved double-shoulder connection 600. The curved secondary shoulder 660 provides an avenue for compressive forces and elevated torques while drilling to move axially and radially (i.e., inward) into the pin connection, reducing box swell (e.g., box material yields). The curved secondary shoulder 660 also balances compressive forces between the primary and secondary shoulder connections. FIG. 6A illustrates a cross-sectional view of the improved double-shoulder connection 600, showing box radial retaining forces and pin radial retaining forces. As shown in FIG. 6A, the curved secondary shoulder 660 reduces the box swell/yielding forces shown in FIG. 3A. See also FIG. 3A (showing standard secondary shoulder 360). In other words, the box radial retaining forces generated by the curved secondary shoulder 660 reduce the box swell/yielding forces, reducing box swell (e.g., box material yields).

As shown in FIG. 6A, a curved secondary shoulder 660 also reduces the pin collapse forces shown in FIG. 3A. See also FIG. 3A (showing a standard secondary shoulder 360). In other words, the pin radial retaining forces generated by the curved secondary shoulder 660 reduce the pin collapse forces, reducing pin nose diving.

As discussed with respect to the standard double-shoulder connection, the combination of box swell and pin collapse can lead to permanent damage to the box connection 610 and/or the pin connection 630. See also FIG. 3A (showing a standard secondary shoulder 360).

In an embodiment, the improved double-shoulder connection 400, 500, 600, 700, 1200, 1400 may be made of any suitable material. For example, suitable materials include, but are not limited to, low alloy steels (e.g., 4140, 4145, 4330, etc.), stainless steels (e.g., 17-4, 304, 316, etc.), super alloys (e.g., Inconel), titanium alloys (e.g., Ti-6Al-4V, Ti-6Al-6V-2Sn, etc.), copper alloys (e.g., Beryllium copper), cobalt alloys (e.g., Stellite), aluminum alloys (e.g., 2024, 6061, 7075, etc.), and combinations and variations thereof. In an embodiment, the improved double-shoulder connection 400, 500, 600, 700, 1200, 1400 may be low alloy steels or stainless steels.

In an embodiment, the improved double-shoulder connection 400, 500, 600, 700, 1200, 1400 may be applied to any suitable product. For example, suitable products include, but are not limited to, drill pipe (DP), heavy weight drill pipe (HWDP), drill collars (DC), pup joints, crossover subs, saver subs, bit subs, float subs, pump-in subs, inside blowout preventers (IBOP), top drive shafts, top drive valves, safety valves, kelly valves, hoisting equipment (e.g., lift subs, lift plugs), swivels, fishing tools, mud motors, rotary steerable tools, drill bits, directional drilling bottom hole assembly (BHA) components, measurement while drilling (MWD) components, logging while drilling (LWD) components, well cleanout tools (e.g., brushes, magnets), completion tools, and combinations and variations thereof. In an embodiment, the improved double-shoulder connection 400, 500, 600, 700, 1200, 1400 may be applied to drill pipe (DP) or heavy weight drill pipe (HWDP) or drill collars (DC) or pup joints.

In an embodiment, the improved double-shoulder connection 400, 500, 600, 700, 1200, 1400 may be applied to any suitable diameter drill pipe (DP). For example, suitable diameter DP includes, but is not limited to, from about 2⅜-inch outer diameter (OD) to about 7⅝-inch OD, and any range or value there between.

In an embodiment, the improved double-shoulder connection 400, 500, 600, 700, 1200, 1400 may be applied to any suitable heavy weight diameter drill pipe (HWDP). For example, suitable diameter HWDP includes, but is not limited to, from about 2⅞-inch OD to about 6⅝-inch OD, and any range or value there between.

In an embodiment, the improved double-shoulder connection 400, 500, 600, 700, 1200, 1400 may be applied to any suitable drill collars (DC). For example, suitable diameter DC includes, but is not limited to, from about 3⅛-inch OD to about 11-inch OD, and any range or value there between.

In an embodiment, the improved double-shoulder connection 400, 500, 600, 700, 1200, 1400 may be applied to any suitable pup joints. For example, suitable diameter pup joints includes, but is not limited to, from about 2⅜-inch OD to about 7⅝-inch OD, and any range or value there between.

### Improved Single-Shoulder Connections

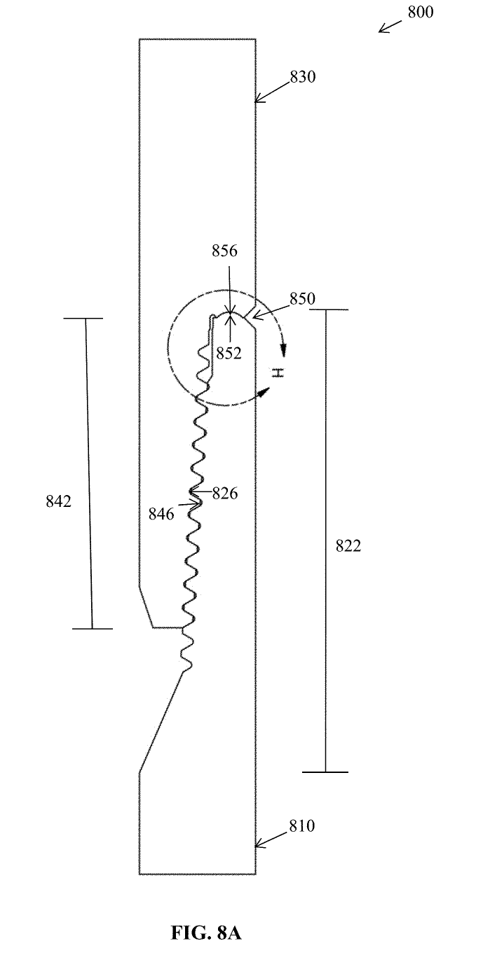

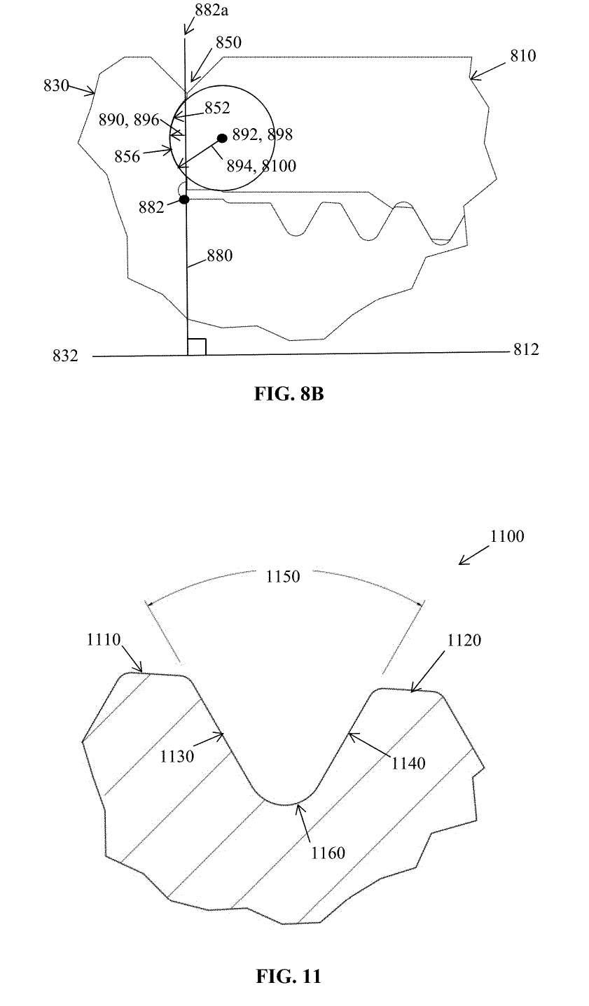

Similar to the double-shoulder connections 400, 500, 600, 700, 1200, 1400, discussed above, a curved primary shoulder 850, 950, 1050, 1250 reduces box swell (e.g., box material yields) and provides better alignment of the box threads 826, 926, 1026 and pin threads 846, 946, 1046 in an improved single-shoulder connection 800, 900, 1000, 1200. The curved primary shoulder 850, 950, 1050 provides an avenue for compressive forces and elevated torques while drilling to move axially and radially (i.e., inward) into the pin connection, reducing box swell. FIGS. 8A, 9 and 10 illustrate a cross-sectional view of an improved single-shoulder connection 800, 900, 1000 with a curved primary shoulder 850, 950, 1050 according to an embodiment of the present invention. As shown in FIGS. 8A, 9 and 10, the improved single-shoulder connection 800, 900, 1000 comprises a box connection 810, 910, 1010 having a box axis (centerline) 812, a pin connection 830, 930, 1030 having a pin axis (centerline) 832, and a primary shoulder 850, 950, 1050.

In an embodiment, the primary shoulder 850 comprises a primary box shoulder 852; and a primary pin shoulder 856. See also FIG. 1A: 112 & FIG. 1B: 132 (showing box and pin made-up).

### Primary Box Shoulder

In an embodiment, the primary box shoulder 852 may be any suitable shape. For example, suitable shapes include, but are not limited to, concave shaped, convex shaped, and variations thereof. In an embodiment, the primary shoulder 852 may be convex shaped.

In an embodiment, the primary box shoulder 852 may be any suitable profile. For example, suitable profiles include, but are not limited to, curved profiles, and variations thereof. In an embodiment, the primary box shoulder 852 may be a curved profile defined by a primary axial box radius height 890, a primary box center point 892 and a primary box radius 894, as discussed below.

In an embodiment, the primary axial box radius height 890 may be from about 0.000 inch to about the length of the primary box radius 894 in inches, and any range or value there between.

In an embodiment, the primary box center point 892 may be located between a box counter bore diameter (i.e., two times a box counter bore radius 118) and a pin bevel diameter (i.e., two times a pin bevel radius 136). In an embodiment, the primary box center point 892 may be about half-way between the box counter bore diameter (i.e., two times a box counter bore radius 118) and the pin bevel diameter (i.e., two times a pin bevel radius 136). In an embodiment, the primary box center point 892 may be about [(box counter bore diameter (i.e., two times a box counter bore radius 118)+pin bevel diameter (i.e., two times a pin bevel radius 136))/2].

In an embodiment, the primary box radius 894 may be greater than about [(pin bevel diameter (i.e., two times pin bevel radius 136)−box counter bore diameter (i.e., two times box counter bore radius 118))/4] inches, and any range or value there between.

In an embodiment, the primary box radius 894 may be greater than about [(pin bevel diameter (i.e., two times pin bevel radius 136)−box counter bore diameter (i.e., two times box counter bore radius 118))/4] inches, and any range or value there between.

### Primary Pin Shoulder

In an embodiment, the primary pin shoulder 856 may be any suitable shape. For example, suitable shapes include, but are not limited to, concave shaped, convex shaped, and variations thereof. In an embodiment, the primary pin shoulder 856 may be concave shaped.

In an embodiment, the primary pin shoulder 856 may be any suitable profile. For example, suitable profiles include, but are not limited to, curved profiles, and variations thereof. In an embodiment, the primary pin shoulder 856 may be a curved profile defined by a primary axial pin radius height 896, a primary pin center point 898 and a primary pin radius 8100, as discussed below.

In an embodiment, the primary axial pin radius height 896 may be from about 0.000 inch to about the length of the primary pin radius 8100 in inches, and any range or value there between.

In an embodiment, the primary pin center point 898 may be located between a box counter bore diameter (i.e., two times a box counter bore radius 118) and a pin bevel diameter (i.e., two times a pin bevel radius 136). In an embodiment, the primary pin center point 898 may be about half-way between the box counter bore diameter (i.e., two times a box counter bore radius 118) and the pin bevel diameter (i.e., two times a pin bevel radius 136). In an embodiment, the primary pin center point 898 may be about [(box counter bore diameter (i.e., two times a box counter bore radius 118)+pin bevel diameter (i.e., two times a pin bevel radius 136))/2].

In an embodiment, the primary pin radius 8100 may be greater than about [(pin bevel diameter (i.e., two times pin bevel radius 136)−box counter bore diameter (i.e., two times box counter bore radius 118))/4] inches, and any range or value there between.

In an embodiment, the primary pin radius 8100 may be greater than about [(pin bevel diameter (i.e., two times pin bevel radius 136)−box counter bore diameter (i.e., two times box counter bore radius 118))/4] inches, and any range or value there between.

In an embodiment, the primary box center point 892 may be about equal to the primary pin center point 898.

In an embodiment, the primary box radius 894 may be about equal to the primary pin radius 8100 to form a first seal. In an embodiment, the primary box radius 894 may be slightly different from the primary pin radius 8100 to form a first seal. In an embodiment, the first seal may be a gas-tight seal.

FIG. 8B illustrates a detailed view H in FIG. 8A, showing the curved primary shoulder 850 according to an embodiment of the present invention. As shown in FIG. 8B, the primary box radius 894 and the primary pin radius 8100 may be greater than about [(pin bevel diameter (i.e., two times pin bevel radius 136)−box counter bore diameter (i.e., two times box counter bore radius 118))/4] inches. Cf. FIG. 2B (showing a standard primary shoulder 250).

In an embodiment, the improved single-shoulder connection 800, 900, 1000, 1200 may be made of any suitable material. For example, suitable materials include, but are not limited to, low alloy steels (e.g., 4140, 4145, 4330, etc.), stainless steels (e.g., 17-4, 304, 316, etc.), super alloys (e.g., Inconel), titanium alloys (e.g., Ti-6Al-4V, Ti-6Al-6V-2Sn, etc.), copper alloys (e.g., Beryllium copper), cobalt alloys (e.g., Stellite), aluminum alloys (e.g., 2024, 6061, 7075, etc.), and combinations and variations thereof. In an embodiment, the improved single-shoulder connection 800, 900, 1000, 1200 may be low alloy steels or stainless steels.

In an embodiment, the improved single-shoulder connection 800, 900, 1000, 1200 may be applied to any suitable product. For example, suitable products include, but are not limited to, drill pipe (DP), heavy weight drill pipe (HWDP), drill collars (DC), pup joints, crossover subs, saver subs, bit subs, float subs, pump-in subs, inside blowout preventers (IBOP), top drive shafts, top drive valves, safety valves, kelly valves, hoisting equipment (e.g., lift subs, lift plugs), swivels, fishing tools, mud motors, rotary steerable tools, drill bits, directional drilling bottom hole assembly (BHA) components, measurement while drilling (MWD) components, logging while drilling (LWD) components, well cleanout tools (e.g., brushes, magnets), completion tools and combinations and variations thereof. In an embodiment, the improved single-shoulder connection 800, 900, 1000, 1200 may be applied to drill pipe (DP) or heavy weight drill pipe (HWDP) or drill collars (DC) or pup joints.

In an embodiment, the improved single-shoulder connection 800, 900, 1000, 1200 may be applied to any suitable diameter drill pipe (DP). For example, suitable diameter DP include, but are not limited to, from about 2⅜-inch outer diameter (OD) to about 7⅝-inch OD, and any range or value there between.

In an embodiment, the improved single-shoulder connection 800, 900, 1000, 1200 may be applied to any suitable heavy weight diameter drill pipe (HWDP). For example, suitable diameter HWDP include, but are not limited to, from about 2⅞-inch OD to about 6⅝-inch OD, and any range or value there between.

In an embodiment, the improved single-shoulder connection 800, 900, 1000, 1200 may be applied to any suitable drill collars (DC). For example, suitable diameter DC include, but are not limited to, from about 3⅛-inch OD to about 11-inch OD, and any range or value there between.

In an embodiment, the improved single-shoulder connection 800, 900, 1000, 1200 may be applied to any suitable pup joints. For example, suitable diameter pup joints include, but are not limited to, from about 2⅜-inch OD to about 7⅝-inch OD, and any range or value there between.

Optional Box Stress Relief Groove and/or Pin Stress Relief Groove

An optional box stress relief groove 980 and/or an optional pin stress relief groove 990 may be applied to a double-shoulder connection 400, 500, 600, 700, 1200, 1400 or a single-shoulder connection 800, 900, 1000, 1200 at portion(s) where premature fatigue failure of the double-shoulder connection or the single-shoulder connection may occur as a result of alternating axial, torsional and bending loads, as discussed above with respect to FIGS. 2A-3B.

FIG. 9 illustrates a cross-sectional view of an improved single-shoulder connection 900 with an optional box stress relief groove 980 and an optional pin stress relief groove 990 according to an embodiment of the present invention. As shown in FIG. 9, the optional box stress relief groove 980 and/or the optional pin stress relief groove 990 removes unengaged threads in potentially stressed portions of the single-shoulder connection 900 so that any bending occurs in portions with smooth surfaces that are relatively free of stress concentrations.

Similar to FIG. 8A, FIG. 9 illustrates a cross-sectional view of an improved single-shoulder connection 900 with a curved primary shoulder 950 according to an embodiment of the present invention. As shown in FIGS. 8 and 9, the improved single-shoulder connection 800, 900 comprises a box connection 810, 910 having a box axis (centerline) 812, a pin connection 830, 930 having a pin axis (centerline) 832, and a primary shoulder 850, 950.

In an embodiment, the curved primary shoulder 850, 950 comprises a primary box shoulder 952, 952; and a primary pin shoulder 856, 956. See also FIG. 1A: 112 & FIG. 1B: 132 (showing box and pin made-up).

### Optional Box Boreback and Pin Stress Relief Groove

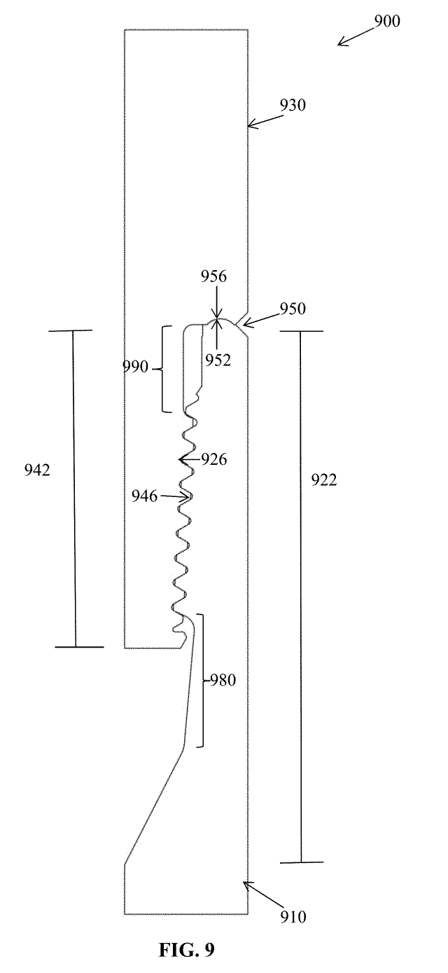

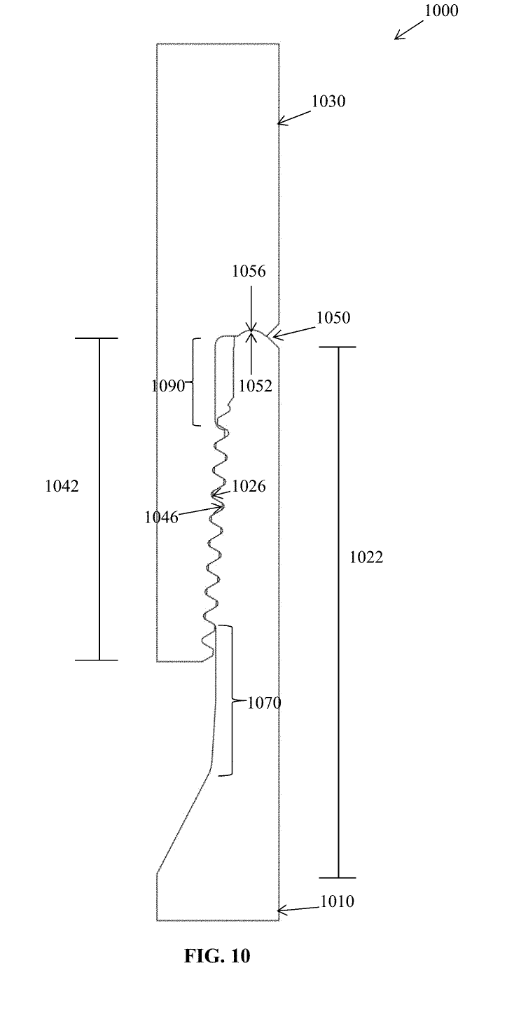

An optional box boreback 1070 may be applied to a single-shoulder connection 800, 900, 1000, 1200 at portion(s) where fatigue may occur as a result of bending; and an optional pin stress relief groove 1090 may be applied to a double-shoulder connection 400, 500, 600, 700, 1200, 1400 or a single-shoulder connection 800, 900, 1000, 1200 at portion(s) where fatigue may occur as a result of bending. FIG. 10 illustrates a cross-sectional view of an improved single-shoulder connection with an optional box boreback 1070 and an optional pin stress relief groove 1090 according to an embodiment of the present invention. As shown in FIG. 10, the optional box boreback 1070 and/or the optional pin stress relief groove 1090 removes unengaged threads in potentially stressed portions of the single-shoulder connection 1000 so that any bending occurs in portions with smooth surfaces that are relatively free of stress concentrations.

Similar to FIG. 8A, FIG. 10 illustrates a cross-sectional view of an improved single-shoulder connection 800, 1000 with a curved primary shoulder 850, 1050 according to an embodiment of the present invention. As shown in FIGS. 8 and 10, the improved single-shoulder connection 800, 1000 comprises a box connection 810, 1010 having a box axis (centerline) 812, a pin connection 830, 1030 having a pin axis (centerline) 832, and a primary shoulder 850, 1050.

In an embodiment, the curved primary shoulder 850, 1050 comprises a primary box shoulder 852, 1052; and a primary pin shoulder 856, 1056. See also FIG. 1A: 112 & FIG. 1B: 132 (showing box and pin made-up).

### Types of Thread Forms

FIG. 11 illustrates a cross-sectional detailed view of a thread form 1100 according to an embodiment of the present invention. As shown in FIG. 11, the thread form 1100 comprises a first thread crest 1110, a second thread crest 1120, a first thread flank 1130, a second thread flank 1140, an included angle 1150 between the first thread flank 1130 and second thread flank 1140, and a thread root 1160.

In an embodiment, any suitable thread form 1100 may be used for the box threads 426, 526, 626, 726, 826, 926, 1026 and/or pin threads 446, 546, 646, 746, 847, 946, 1046. For example, suitable shapes include, but are not limited to, circular, square, triangular, trapezoidal and variations thereof. In an embodiment, the thread form 1100 may be triangle shaped or a variation thereof.

For example, any suitable shape for the first thread crest 1110 and/or the second thread crest 1120 may be used for the box threads 426, 526, 626, 726, 826, 926, 1026 and/or pin threads 446, 546, 646, 746, 846, 946, 1046. For example, suitable shapes include, but are not limited to, circular, square, triangular, trapezoidal and variations thereof. In an embodiment, the first thread crest 1110 and/or the second thread crest 1120 may be triangle shaped or a variation thereof.

For example, any suitable shape for the first thread flank 1130 and/or the second thread flank 1140 may be used for the box threads 426, 526, 626, 726, 826, 926, 1026 and/or pin threads 446, 546, 646, 746, 846, 946, 1046. For example, suitable shapes include, but are not limited to, concave, convex, straight and combinations or variations thereof.

In an embodiment, any suitable shape for the thread root 1160 may be used for the box threads 426, 526, 626, 726, 826, 926, 1026 and/or pin threads 446, 546, 646, 746, 846, 946, 1046. For example, suitable shapes include, but are not limited to, circular, square, triangular, trapezoidal and variations thereof. In an embodiment, the thread root 1160 may be triangle shaped or a variation thereof.

In an embodiment, any suitable included angle 1150 may be used for the box threads 426, 526, 626, 726, 826, 926, 1026 and/or pin threads 446, 546, 646, 746, 846, 946, 1046. For example, suitable included angles 1150 may be from about 29 degrees to about 90 degrees, and any range or value there between. In an embodiment, the included angle 1150 may be about 60 degrees.

### Optional Thread Treatments

An optional thread treatment may be applied to the box threads 426, 526, 626, 726, 826, 926, 1026 and/or the pin threads 446, 546, 646, 746, 846, 946, 1046 where fatigue may occur. In an embodiment, any suitable optional thread treatment may be applied to the box threads 426, 526, 626, 726, 826, 926, 1026 and/or pin threads 446, 546, 646, 746, 846, 946, 1046. For example, suitable thread treatments include, but are not limited to, cold rolling, shot peening, phosphating, fluoropolymer coating, ceramic coating, chrome plating, anodizing, and combinations or variations thereof. In an embodiment, the optional thread treatment may be cold rolling or shot peening or fluropolymer coating or anodizing.

### Method for Determining a Primary Connection Shoulder Location

FIGS. 12A, 12B-1 and 12B-2 illustrate cross-sectional views of an improved primary connection shoulder 1200 according to an embodiment of the present invention.

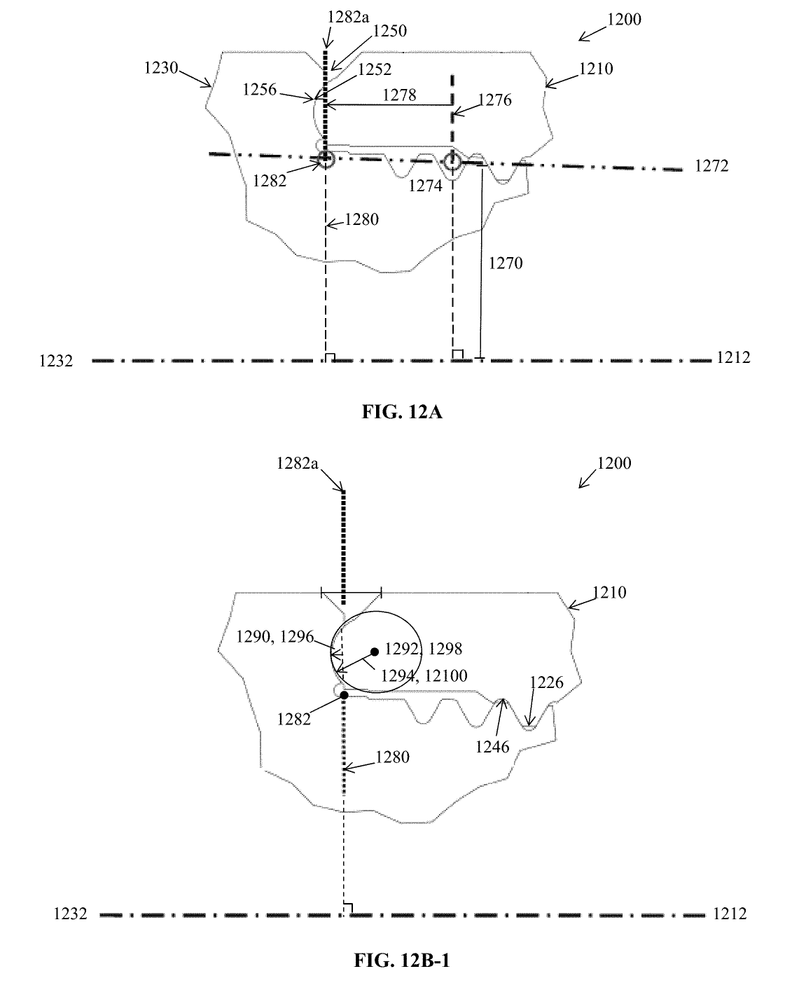

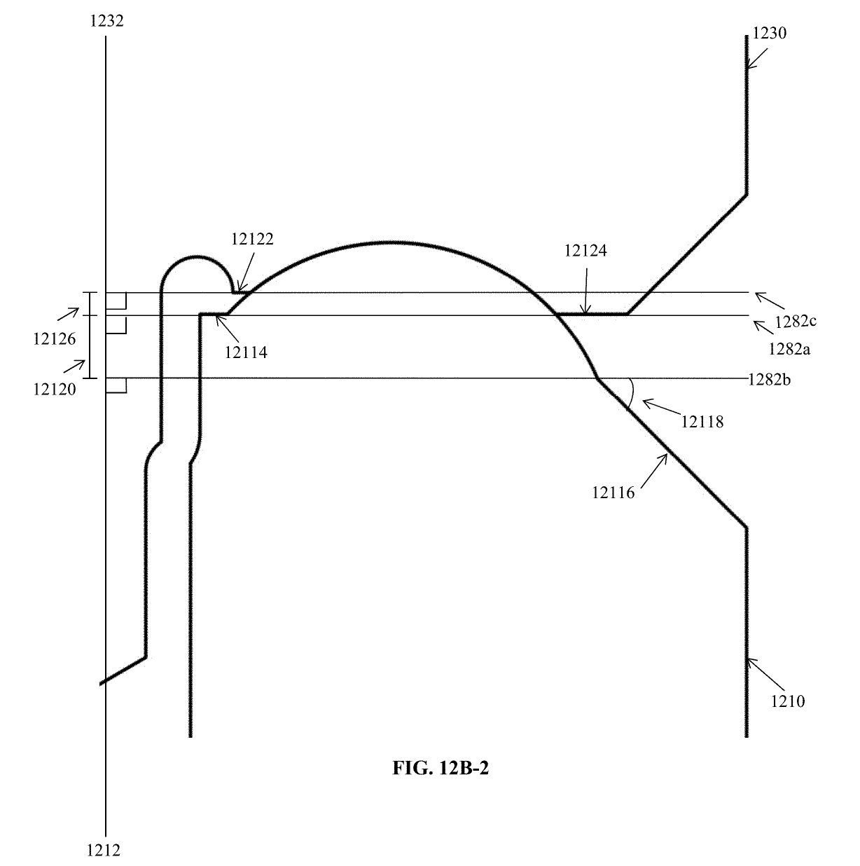

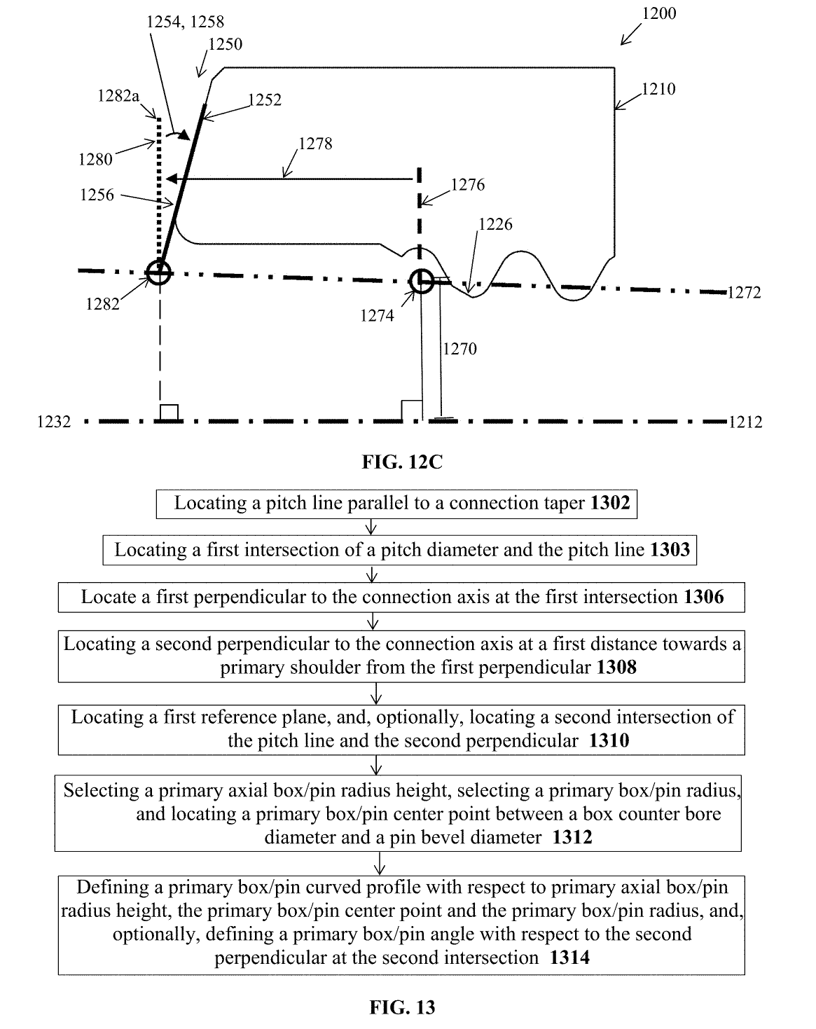

As shown in FIGS. 12A and 12B-1, a pitch diameter (i.e., two times the pitch radius 1270) intersects a pitch line 1272 at a first intersection 1274. A first perpendicular 1276 to the connection box/pin axis 1212, 1232 may be offset a first distance 1278 towards a primary box/pin shoulder 1250 to locate a second perpendicular 1280 to the connection box/pin axis 1212, 1232 at the first distance 1278. The pitch line 1272 intersects the second perpendicular 1280 at a second intersection 1282. In an embodiment, the second intersection 1282 may be equal to a datum intersection.

In an embodiment, the first distance 1278 may be from about 0.5 inch to about 2.50 inches, and any range or value there between. In an embodiment, the first distance 1278 may be from about 0.625 inch to about 2.250 inch. In an embodiment, the first distance 1278 may be about 0.625 inches.

In an embodiment, a first reference plane 1282a may be co-planer with the second perpendicular 1280 and perpendicular to the connection box/pin axis 1212, 1232.

In an embodiment, the primary shoulder 1250 comprises a primary box shoulder 1252; and a primary pin shoulder 1256. See also FIG. 1A: 112 & FIG. 1B: 132 (showing box and pin made-up).

### Primary Box Shoulder

In an embodiment, the primary box shoulder 1252 may be any suitable shape. For example, suitable shapes include, but are not limited to, concave shaped, conical shaped, convex shaped, cylindrical shaped, conical-cylindrical shaped, and variations thereof. In an embodiment, the primary shoulder 1252 may be convex shaped.

In an embodiment, the primary box shoulder 1252 may be any suitable profile. For example, suitable profiles include, but are not limited to, angled profiles, curved profiles, and variations thereof. In an embodiment, the primary box shoulder 1252 may be a curved profile defined by a primary axial box radius height 1290, a primary box center point 1292 and a primary box radius 1294, as discussed below.

In an embodiment, the primary axial box radius height 1290 may be from about 0.000 inch to about the length of the primary box radius 1294 in inches, and any range or value there between.

In an embodiment, the primary box center point 1292 may be located between the box counter bore diameter (i.e., two times box counter bore radius 118) and the pin bevel diameter (i.e., two times the pin bevel radius 136), and any range or value there between. In an embodiment, the primary box center point 1292 may be about half-way between the box counter bore diameter (i.e., two times a box counter bore radius 118) and the pin bevel diameter (i.e., two times a pin bevel radius 136). In an embodiment, the primary box center point 1292 may be located at about [(pin bevel diameter (i.e., two times pin bevel radius 136)+box counter bore diameter (i.e., two times box counter bore radius 118))/2].

In an embodiment, the primary box radius 1294 may be greater than about [(pin bevel diameter (i.e., two times pin bevel radius 136)−box counter bore diameter (i.e., two times box counter bore radius 118))/4] inches.

In an embodiment, the primary box radius 1294 may be greater than about [(pin bevel diameter (i.e., two times pin bevel radius 136)−box counter bore diameter (i.e., two times box counter bore radius 118))/4] inches.

### Primary Pin Shoulder

In an embodiment, the primary pin shoulder 1256 may be any suitable shape. For example, suitable shapes include, but are not limited to, concave shaped, conical shaped, convex shaped, cylindrical shaped, conical-cylindrical shaped, and variations thereof. In an embodiment, the primary pin shoulder 1256 may be concave shaped.

In an embodiment, the primary pin shoulder 1256 may be any suitable profile. For example, suitable profiles include, but are not limited to, curved profiles, and variations thereof. In an embodiment, the primary pin shoulder 1256 may be a curved profile defined by a primary axial pin radius height 1296, a primary pin center point 1298 and a primary pin radius 12100, as discussed below.

In an embodiment, the primary axial pin radius height 1296 may be from about 0.000 inch to about the length of the primary pin radius 12100 in inches, and any range or value there between.

In an embodiment, the primary axial box radius height 1290 may be about equal to the primary axial pin radius height 1296.

In an embodiment, the primary pin center point 1298 may be located between the box counter bore diameter (i.e., two times box counter bore radius 118) and the pin bevel diameter (i.e., two times the pin bevel radius 136), and any range or value there between. In an embodiment, the primary pin center point 1298 may be about half-way between the box counter bore diameter (i.e., two time a box counter bore radius 118) and the pin bevel diameter (i.e., two times a pin bevel radius 136). In an embodiment, the primary pin center point 1298 may be located at about [(pin bevel diameter (i.e., two times pin bevel radius 136)+box counter bore diameter (i.e., two times box counter bore radius 118))/2] inches.

In an embodiment, the primary pin radius 12100 may be greater than about [(pin bevel diameter (i.e., two times pin bevel radius 136)−box counter bore diameter (i.e., two times box counter bore radius 118))/4] inches.

In an embodiment, the primary pin radius 12100 may be greater than about [(pin bevel diameter (i.e., two times pin bevel radius 136)−box counter bore diameter (i.e., two times box counter bore radius 118))/4] inches.

In an embodiment, the primary box radius 1294 may be about equal to the primary pin radius 12100 to form a first seal. In an embodiment, the primary box radius 1294 may be slightly different from the primary pin radius 12100 to form a first seal. In an embodiment, the first seal may be a gas-tight seal.

As shown in FIG. 12B-2, the primary box shoulder 1252 may have a first flat region 12114 at an inner edge of the curved profile and/or a first angled region 12116 at an outer edge of the curved profile.

In an embodiment, the first flat region 12114 may be co-planer with the first reference plane 1282a and perpendicular to the connection axis 1212, 1232.

In an embodiment, the first angled region 12116 may be at a first angled region angle 12118 with respect to a first offset reference plane 1282b. In an embodiment, the first offset reference plane 1282b may be a first offset distance 12120 from the first reference plane 1282a towards the box threads 1226.

In an embodiment, the first angled region angle 12118 may be from about 10 degrees to about 65 degrees, and any range or value there between. In an embodiment, the first angled region angle 12118 may be from about 15 degrees to about 60 degrees. In an embodiment, the first angled region angle 12118 may be about 45 degrees.

In an embodiment, the first offset distance 12120 may be from about 0.010 inch to about 0.030 inch, and any range or value there between. In an embodiment, the first offset distance 12120 may be about 0.015 inch.

As shown in FIG. 12B-2, the primary pin shoulder 1256 may have a second flat region 12122 at an inner edge of the curved profile and/or a third flat region 12124 at an outer edge of the curved profile.

In an embodiment, the second flat region 12122 at the inner edge of the curved profile may be coplanar with a second offset reference plane 1282c. In an embodiment, the second offset reference plane 1282c may be a second offset distance 12126 from the first reference plane 1282a away from the pin threads 1246.

In an embodiment, the second flat distance 12126 may be from about 0.010 inch to about 0.030 inch, and any range or value there between. In an embodiment, the second flat distance 12126 may be about 0.015 inch.

In an embodiment, the third flat region 12124 at the outer edge of the curved profile may be co-planer with the first reference plane 1282a.

FIG. 12C illustrates a cross-sectional view of an improved primary connection shoulder 1200 according to an embodiment of the present invention.

As shown in FIG. 12C, a pitch diameter (i.e., two times the pitch radius 1270) intersects a pitch line 1272 at a first intersection 1274. A first perpendicular 1276 to the connection box/pin axis 1212, 1232 may be offset a first distance 1278 towards a primary box/pin shoulder 1250 to locate a second perpendicular 1280 to the connection box/pin axis 1212, 1232 at the first distance 1278. The pitch line 1272 intersects the second perpendicular 1280 at a second intersection 1282. In an embodiment, the second intersection 1282 may be equal to a datum intersection.

In an embodiment, the first distance 1278 may be from about 0.5 inch to about 2.50 inches, and any range or value there between. In an embodiment, the first distance 1278 may be from about 0.625 inch to about 2.250 inches. In an embodiment, the first distance 1278 may be about 0.625 inch.

In an embodiment, the primary shoulder 1250 comprises a primary box shoulder 1252 at a primary box angle 1254 with respect to a second perpendicular 1280 to the box axis 1212 at a second intersection 1282 of the box connection; and a primary pin shoulder 1256 at a primary pin angle 1258 with respect to the second perpendicular 1280 to the pin axis 1232 at the second intersection 1282 of the pin connection. See also FIG. 1A: 112 & FIG. 1B: 132 (showing box and pin made-up). In an embodiment, the second intersection 1282 may be equal to a datum intersection.

In an embodiment, the primary box shoulder 1252 may be any suitable shape. For example, suitable shapes include, but are not limited to, conical shaped, cylindrical shaped, conical-cylindrical shaped, and variations thereof. In an embodiment, the primary shoulder 1252 may be conical shaped (outside of cone, male).

In an embodiment, the primary pin shoulder 1256 may be any suitable shape. For example, suitable shapes include, but are not limited to, conical shaped, cylindrical shaped, conical-cylindrical shaped, and variations thereof. In an embodiment, the primary pin shoulder 1256 may be conical shaped (inside of cone, female).

In an embodiment, the primary box shoulder 1252 may be any suitable profile. For example, suitable profiles include, but are not limited to, angled profiles. In an embodiment, the primary box shoulder 1252 may be an angled profile defined by a primary box angle 1254, as discussed below.

In an embodiment, the primary box angle 1254 may be from greater than about 0 degrees to less than or equal to about 15 degrees, and any range or value there between. In an embodiment, the primary box angle 1254 may be from greater than about 0 degrees to less than or equal to about 10 degrees. In an embodiment, the primary box angle 1254 may be about 5 degrees. In an embodiment, the primary box angle 1254 may be about 0 degrees.

In an embodiment, the primary pin shoulder 1256 may be any suitable profile. For example, suitable profiles include, but are not limited to, angled profiles. In an embodiment, the primary pin shoulder 1256 may be an angled profile defined by a primary pin angle 1258, as discussed below.

In an embodiment, the primary pin angle 1258 may be from greater than about 0 degrees to less than or equal to about 15 degrees, and any range or value there between. In an embodiment, the primary pin angle 1258 may be from greater than about 0 degrees to less than or equal to about 10 degrees. In an embodiment, the primary pin angle 1258 may be about 5 degrees. In an embodiment, the primary pin angle 1258 may be about 0 degrees.

In an embodiment, the primary box angle 1254 may be about equal to the primary pin angle 1258 to form a first seal.

In an embodiment, the primary box angle 1254 may be slightly different from the primary pin angle 1258 to form a first seal. In an embodiment, the first seal may be a gas-tight seal.

FIG. 13 illustrates a flowchart of a method to determine a primary connection shoulder location 1300 according to an embodiment of the present invention. As shown in FIG. 13, the method 1300 comprises locating a pitch line parallel to a connection box/pin taper 1302; locating a first intersection of a pitch diameter and the pitch line 1304; locating a first perpendicular to a connection box/pin axis at the first intersection 1306; locating a second perpendicular to the connection pin/box axis at a first distance towards a primary box/pin shoulder from the first perpendicular (and parallel to the first perpendicular) 1308; and locating a first reference plane co-planer with the second perpendicular and perpendicular to the connection box/pin axis, and, optionally, locating a second intersection of the pitch line and the second perpendicular 1310.

In an embodiment, the method 1300 further comprises selecting a primary axial box/pin radius height, selecting a primary box/pin radius and locating a primary box/pin center point between a box counter bore diameter and a pin bevel diameter 1312.

In an embodiment, the method 1300 further comprises, defining a primary box/pin curved profile with respect to primary axial box/pin radius height, the primary box/pin center point and the primary box/pin radius, and, optionally, defining a primary box/pin angle with respect to the second perpendicular at the second intersection 1314.

### Method for Determining a Secondary Connection Shoulder Location

FIGS. 14A, 14B-1 and 14B-2 illustrate cross-sectional views of an improved secondary connection shoulder 1400 according to an embodiment of the present invention. As discussed above with respect to FIG. 12, the pitch line 1272 intersects the second perpendicular 1280, 1480 at a second intersection 1282, 1482. In an embodiment, the second intersection 1282, 1482 may be equal to a datum intersection.

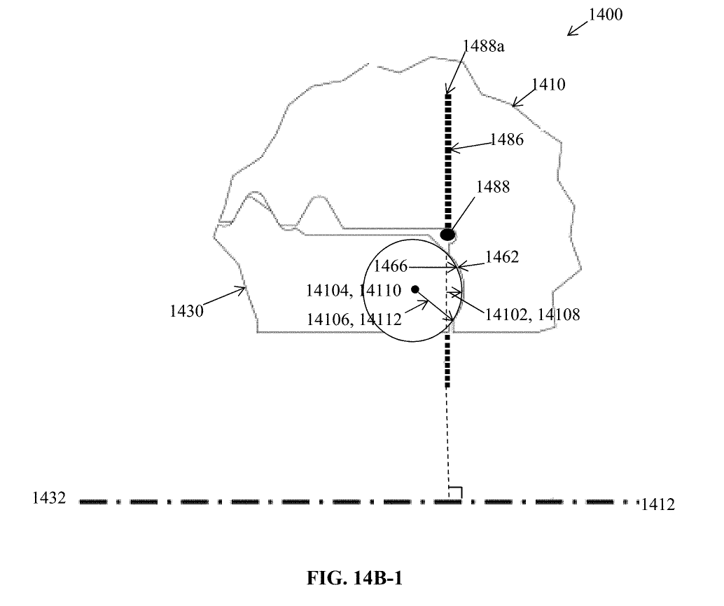

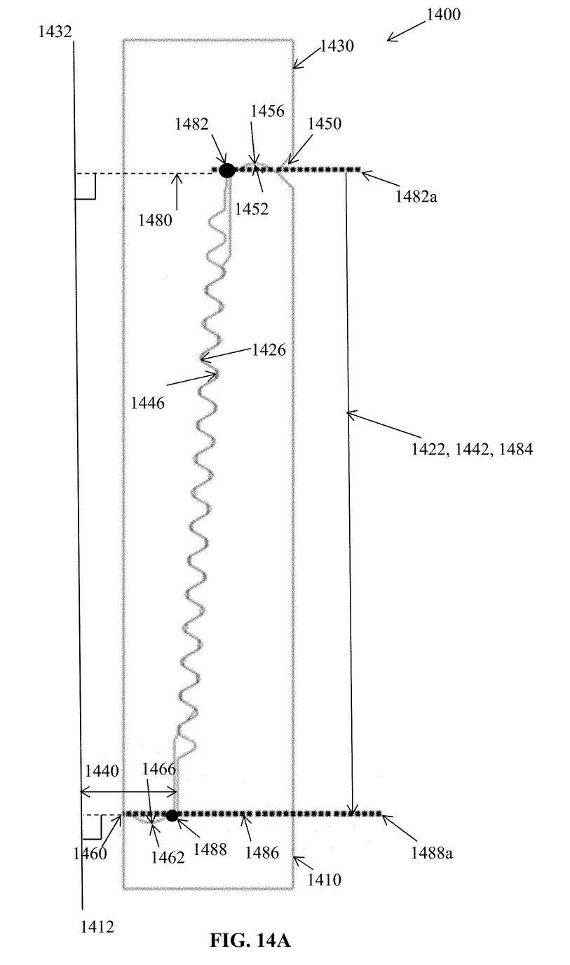

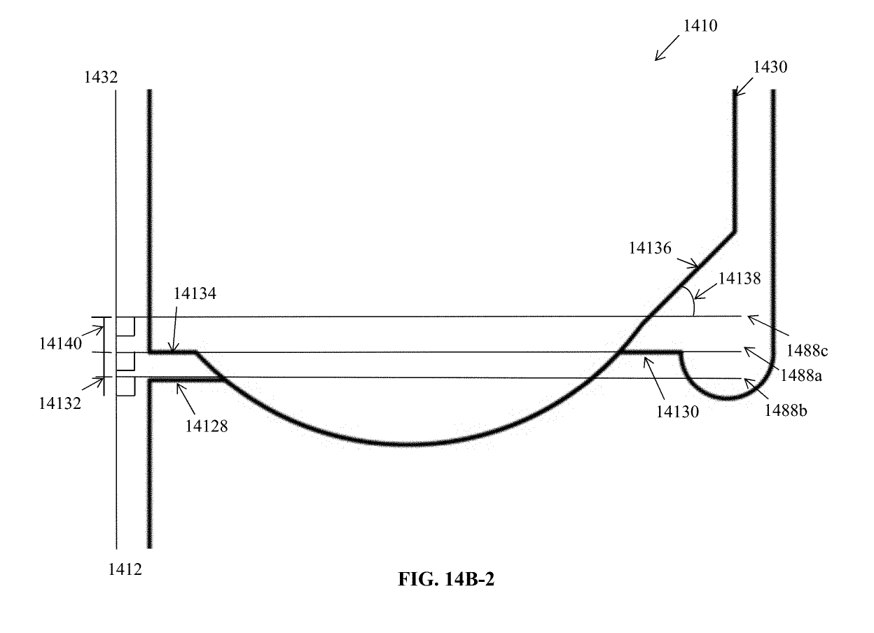

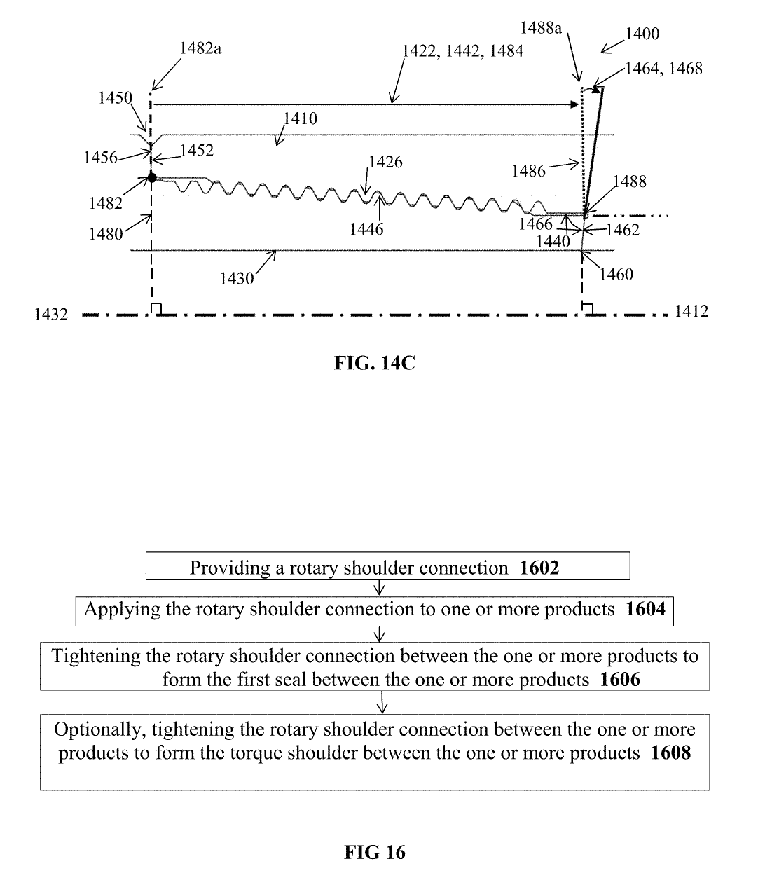

As shown in FIGS. 14A and 14B-1, a second perpendicular 1480 to the connection box/pin axis 1412, 1432 may be offset a second distance 1484 towards a secondary box/pin shoulder 1460 to locate a third perpendicular 1486 to the connection box/pin axis 1412, 1432 at the second distance 1484.

The pin nose outer diameter (i.e., two times the pin radius 1440) intersects the third perpendicular 1486 at a third intersection 1488.

In an embodiment, the second distance 1484 may be any suitable distance. In an embodiment, the second distance 1484 may be equal to the connection length. The connection length varies with connection size.

In an embodiment, the second distance 1484 may be from about 1 inch to about 8 inches, and any range or value there between. In an embodiment, the second distance 1484 may be from about 2 inches to about 8 inches.

In an embodiment, the secondary shoulder 1460 comprises a secondary box shoulder 1462; and a secondary pin shoulder 1466. See also FIG. 1A: 112 & FIG. 1B: 132 (showing box and pin made-up).

### Secondary Box Shoulder

In an embodiment, the secondary box shoulder 1462 may be any suitable shape. For example, suitable shapes include, but are not limited to, concave shaped, conical shaped, convex shaped, cylindrical shaped, conical-cylindrical shaped, and variations thereof. In an embodiment, the secondary shoulder 1462 may be concave shaped.

In an embodiment, the secondary box shoulder 1462 may be any suitable profile. For example, suitable profiles include, but are not limited to, angled profiles, curved profiles, and variations thereof. In an embodiment, the secondary box shoulder 1462 may be a curved profile defined by a secondary axial box radius height 14102, a secondary box center point 14104 and a secondary box radius 14106, as discussed below.

In an embodiment, the secondary axial box radius height 14102 may be from about 0.000 inch to about the length of the secondary box radius 14106 in inches, and any range or value there between.

In an embodiment, the secondary box center point 14104 may be located between a pin nose outer diameter (i.e., two times pin nose radius 140) and a pin nose inner diameter (i.e., two times pin nose inner radius 240a), and any range or value there between. In an embodiment, the secondary box center point 14104 may be located about half-way between a pin nose outer diameter (i.e., two times pin nose radius 140) and a pin nose inner diameter (i.e., two times pin nose inner radius 240a). In an embodiment, the secondary box center point 14104 may be located about [(pin nose outer diameter (i.e., two times pin nose radius 140)+pin nose inner diameter (i.e., two times pin nose inner radius 240a))/2].

In an embodiment, the secondary box radius 14106 may be greater than about [(pin nose outer diameter (i.e., two times pin nose radius 140)−pin nose inner diameter (i.e., two times pin nose inner radius 240a))/4] inches, and any range or value there between.

### Secondary Pin Shoulder

In an embodiment, the secondary pin shoulder 1466 may be any suitable shape. For example, suitable shapes include, but are not limited to, concave shaped, conical shaped, convex shaped, cylindrical shaped, conical-cylindrical shaped, and variations thereof. In an embodiment, the secondary pin shoulder 1466 may be convex shaped.

In an embodiment, the secondary pin shoulder 1466 may be any suitable profile. For example, suitable profiles include, but are not limited to, angled profiles, curved profiles, and variations thereof. In an embodiment, the secondary pin shoulder 1466 may be a curved profile defined by a secondary axial pin radius height 14108, a secondary pin center point 14110 and a secondary pin radius 14112, as discussed below.

In an embodiment, the secondary axial pin radius height 14108 may be from about 0.000 inch to about the length of the secondary pin radius 14112 in inches, and any range or value there between.

In an embodiment, the secondary axial box radius height 14102 may be about equal to the secondary pin axial height 14108.

In an embodiment, the secondary pin center point 14110 may be located between a pin nose outer diameter (i.e., two times pin nose radius 140) and a pin nose inner diameter (i.e., two time pin nose inner radius 240a), and any range or value there between. In an embodiment, the secondary pin center point 14110 may be located about half-way between a pin nose outer diameter (i.e., two times pin nose radius 140) and a pin nose inner diameter (i.e., two times pin nose inner radius 240a). In an embodiment, the secondary pin center point 14110 may be located about [(pin nose outer diameter (i.e., two times pin nose radius 140)+pin nose inner diameter (i.e., two times pin nose inner radius 240a))/2].

In an embodiment, the secondary pin radius 14112 may be greater than about [(pin nose outer diameter (i.e., two times pin nose radius 140)−pin nose inner diameter (i.e., two times pin nose inner radius 240a))/4] inches, and any range or value there between.

In an embodiment, the secondary box center point 14104 may be about equal to the secondary pin center point 14110.

In an embodiment, the secondary box radius 14106 may be about equal to the secondary pin radius 14112 to form a torque shoulder.

In an embodiment, the secondary box radius 14106 may be slightly different from the secondary pin radius 14112 to form a torque shoulder that is a second seal. In an embodiment, the torque shoulder or the second seal may be a gas-tight seal.

As shown in FIG. 14B-2, the secondary box shoulder 1462 may have a fourth flat region 14128 at an inner edge of the curved profile and/or a fifth flat region 14130 at an outer edge of the curved profile.

In an embodiment, the fourth flat region 14128 at the inner edge of the curved profile may be coplanar with a third offset reference plane 1488b. In an embodiment, the third offset reference plane 1488b may be a third offset distance 14132 from the second reference plane 1488a away from the box threads 1426.

In an embodiment, the third offset distance 14132 may be from about 0.010 inch to about 0.030 inch, and any range or value there between. In an embodiment, the third offset distance 14132 may be about 0.015 inch.

In an embodiment, the fifth flat region 14130 at the outer edge of the curved profile may be co-planer with the second reference plane 1488a and perpendicular to the connection axis 1412, 1432.

As shown in FIG. 14B-2, the secondary pin shoulder 1466 may have a sixth flat region 14134 at an inner edge of the curved profile and a second angled region 14136 at an outer edge of the curved profile.

In an embodiment, the sixth flat region 14134 at the inner edge of the curved profile may be co-planer with the second reference plane 1488a and perpendicular to the connection axis 1412, 1432.

In an embodiment, the second angled region 14136 may be at a second angled region angle 14138 with respect to a fourth offset reference plane 1482c. In an embodiment, the fourth offset reference plane 1488c may be a fourth offset distance 14140 from the second reference plane 1488a towards the pin threads 1446.

In an embodiment, the first angled region angle 12118 may be from about 10 degrees to about 65 degrees, and any range or value there between. In an embodiment, the second angled region angle 14138 may be from about 15 degrees to about 60 degrees. In an embodiment, the second angled region angle 14138 may be about 45 degrees.

In an embodiment, the fourth offset distance 14140 may be from about 0.010 inch to about 0.030 inch, and any range or value there between. In an embodiment, the fourth offset distance 14140 may be about 0.015 inch.

FIG. 14C illustrates a cross-sectional view of an improved secondary connection shoulder 1400 according to an embodiment of the present invention. As discussed above with respect to FIG. 12C, the pitch line 1272 intersects the second perpendicular 1280, 1480 at a second intersection 1282, 1482. In an embodiment, the second intersection 1482 may be equal to a datum intersection.

A second perpendicular 1480 to the connection box/pin axis 1412, 1432 may be offset a second distance 1484 towards a secondary box/pin shoulder 1460 to locate a third perpendicular 1486 to the connection box/pin axis 1412, 1432 at the second distance 1484.

The pin nose outer diameter (i.e., two times pin nose radius 1440) intersects the third perpendicular 1486 at a third intersection 1488.

In an embodiment, the second distance 1484 may be any suitable distance. In an embodiment, the second distance 1484 may be equal to the connection length. The connection length varies with connection size.

In an embodiment, the second distance 1484 may be about 2 inches to about 8 inches, and any range or value there between.

In an embodiment, the secondary shoulder 1460 comprises a secondary box shoulder 1462 at a secondary box angle 1464 with respect to a third perpendicular 1486 to the box axis 1412 at a third intersection 1488 of the box connection; and a secondary pin shoulder 1466 at a secondary pin angle 1468 with respect to the third perpendicular 1486 to the pin axis 1432 at the third intersection 1488 of the pin connection. See also FIG. 1A: 112 & FIG. 1B: 132 (showing box and pin made-up).

### Secondary Box Shoulder

In an embodiment, the secondary box shoulder 1462 may be any suitable shape. For example, suitable shapes include, but are not limited to, conical shaped, cylindrical shaped, conical-cylindrical shaped, and variations thereof. In an embodiment, the secondary shoulder 1462 may be conical shaped (outside of cone, male).

In an embodiment, the secondary box shoulder 1462 may be any suitable profile. For example, suitable profiles include, but are not limited to, angled profiles. In an embodiment, the secondary box shoulder 1462 may be an angled profile defined by a secondary box angle 1464, as discussed below.

In an embodiment, the secondary box angle 1464 may be from greater than or equal to about 0 degrees to less than or equal to 15 degrees, and any range or value there between. In an embodiment, the secondary box angle 1464 may be from greater than or equal to about 0 degrees to less than or equal to 10 degrees. In an embodiment, the secondary box angle 1464 may be about 5 degrees. In an embodiment, the secondary box angle 1464 may be about 0 degrees.

### Secondary Pin Shoulder

In an embodiment, the secondary pin shoulder 1466 may be any suitable shape. For example, suitable shapes include, but are not limited to, conical shaped, cylindrical shaped, conical-cylindrical shaped, and variations thereof. In an embodiment, the secondary pin shoulder 1466 may be conical shaped (inside of cone, female).

In an embodiment, the secondary pin shoulder 1466 may be any suitable profile. For example, suitable profiles include, but are not limited to, angled profiles. In an embodiment, the secondary pin shoulder 1466 may be an angled profile defined by a secondary pin angle 1468, as discussed below.

In an embodiment, the secondary pin angle 1468 may be from greater than or equal to about 0 degrees to less than or equal to 15 degrees, and any range or value there between. In an embodiment, the secondary pin angle 1468 may be from greater than or equal to about 0 degrees to less than or equal to 10 degrees. In an embodiment, the secondary pin angle 1468 may be about 5 degrees. In an embodiment, the secondary pin angle 1468 may be about 0 degrees.

In an embodiment, the secondary box angle 1464 may be about equal to the secondary pin angle 1468 to form a torque shoulder.

In an embodiment, the secondary box angle 1464 may be slightly different from the secondary pin angle 1468 to form a torque shoulder that is a second seal. In an embodiment, the torque shoulder or the second seal may be a gas-tight seal.

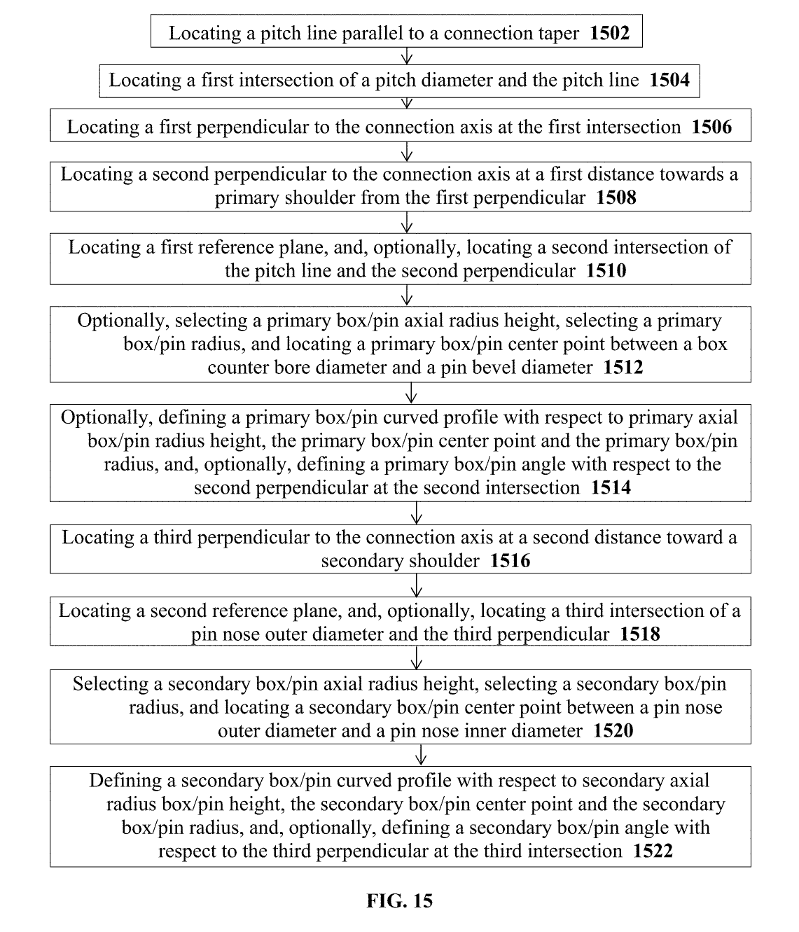

FIG. 15 illustrates a flowchart of a method to determine a secondary connection shoulder location 1500 according to an embodiment of the present invention. As shown in FIG. 15, the method 1500 comprises locating a pitch line parallel to a connection box/pin taper 1502; locating a first intersection of a pitch diameter and the pitch line 1504; locating a first perpendicular to the connection box/pin axis at the first intersection 1506; locating a second perpendicular to the connection pin/box axis at a first distance towards a primary box/pin shoulder from the first perpendicular (and parallel to the first perpendicular) 1508; locating a first reference plane, and, optionally, locating a second intersection of the pitch line and the second perpendicular 1510; selecting a primary axial box/pin radius height, selecting a primary box/pin radius, and locating a primary box/pin center point between a box counter bore diameter and a pin bevel diameter 1512; defining a primary box/pin curved profile with respect to primary axial box/pin radius height, the primary box/pin center point and the primary box/pin radius, and, optionally, defining a primary box/pin angle with respect to the second perpendicular at the second intersection 1514; locating a third perpendicular to the connection box/pin axis at a second distance (connection length) toward a secondary box/pin shoulder (and parallel to the second perpendicular) 1516; and locating a second reference plane, and, optionally, locating a third intersection of a pin nose outer diameter and the third perpendicular 1518.

In an embodiment, the method 1500 further comprises selecting a secondary axial box/pin radius height, selecting a secondary box/pin radius, and locating a secondary box/pin center point between a pin nose outer diameter and a pin nose inner diameter 1520.

In an embodiment, the method 1500 further comprises, defining a secondary box/pin curved profile with respect to secondary axial box/pin radius height, the secondary box/pin center point and the secondary box/pin radius, and, optionally, defining a secondary box/pin angle with respect to the third perpendicular at the third intersection 1522.

Method of Using Improved Double-Shoulder Connection with Curved Primary Shoulder or Improved Single-Shoulder Connection with Curved Primary Shoulder

FIG. 16 illustrates a flowchart of a method of using an improved double-shoulder connection with a curved primary shoulder or an improved single-shoulder connection with a curved primary shoulder 1600 according to an embodiment of the present invention. As shown in FIG. 12, the method 1600 comprises providing a rotary shoulder connection 1602, and applying the rotary shoulder connection to one or more products 1604.

In an embodiment, the rotary shoulder connection may be the improved double-shoulder connection 400, 500, 700, 1200 with a curved primary shoulder 450, 550, 750, 1250 or the improved double-shoulder connection 600 with a curved secondary shoulder 660, or the improved single-shoulder connection 800, 900, 1000, 1200 with a curved primary shoulder 850, 950, 1050, 1250, as discussed above.

In an embodiment, the rotary shoulder connection may be the improved double-shoulder connection 400, 500, 600, 700, 1200, 1400 with a curved primary shoulder 450, 550, 750, 1250 and/or a curved secondary shoulder 660, 760, 1460, as discussed above.

In an embodiment, the method 1600 further comprises tightening the rotary shoulder connection between the one or more products to form a first seal at an angled primary shoulder 450, 550, 650, 750, 850, 950, 1050, 1250.

In an embodiment, the method 1600 further comprises tightening the rotary shoulder connection between the one or more products to form a first seal at a curved primary shoulder 450, 550, 750, 1250.

In an embodiment, the method 1600 further comprises tightening the rotary shoulder connection between one or more products to form a torque shoulder at a curved secondary shoulder 660, 760, 1460.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms (e.g., “outer” and “inner,” “upper” and “lower,” “first” and “second,” “internal” and “external,” “above” and “below” and the like) are used as words of convenience to provide reference points and, as such, are not to be construed as limiting terms.

The embodiments set forth herein are presented to best explain the present invention and its practical application and to thereby enable those skilled in the art to make and utilize the invention. However, those skilled in the art will recognize that the foregoing description has been presented for the purpose of illustration and example only. The description as set forth is not intended to be exhaustive or to limit the invention to the precise form disclosed. Many modifications and variations are possible in light of the above teaching without departing from the spirit and scope of the following claims.

Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

### Definitions

As used herein, the terms “a,” “an,” “the,” and “said” mean one or more, unless the context dictates otherwise.

As used herein, the term “about” means the stated value plus or minus a margin of error plus or minus 10% if no method of measurement is indicated.

As used herein, the term “or” means “and/or” unless explicitly indicated to refer to alternatives only or if the alternatives are mutually exclusive.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “containing,” “contains,” and “contain” have the same open-ended meaning as “comprising,” “comprises,” and “comprise,” provided above.

As used herein, the terms “having,” “has,” and “have” have the same open-ended meaning as “comprising,” “comprises,” and “comprise,” provided above.

As used herein, the terms “including,” “includes,” and “include” have the same open-ended meaning as “comprising,” “comprises,” and “comprise,” provided above.

As used herein, the phrase “consisting of” is a closed transition term used to transition from a subject recited before the term to one or more material elements recited after the term, where the material element or elements listed after the transition term are the only material elements that make up the subject.

As used herein, the phrase “material yields” means the material has exceeded its modulus of elasticity.

As used herein, the term “simultaneously” means occurring at the same time or about the same time, including concurrently.

### INCORPORATION BY REFERENCE

All patents and patent applications, articles, reports, and other documents cited herein are fully incorporated by reference to the extent they are not inconsistent with this invention.

What is claimed is:

1. A rotary shoulder connection comprising:
(a) A box connection having a box axis, wherein the box connection has a box outer radius, a box counter bore radius and a box inner radius, and box threads having a box thread form cut along a box taper;
(b) A pin connection having a pin axis, wherein the pin connection has a pin nose inner radius, a pin outer radius, a pin cylinder radius and a pin nose radius, and pin threads having a pin thread form cut along a pin taper to align with the box threads inside the box connection; and
(c) A primary shoulder connection at a first end of the box connection and a first end of the pin connection comprising:
i. A primary box shoulder with a first curved profile defined by a primary axial box radius height, a primary box center point and a primary box radius;
ii. A primary pin shoulder with a second curved profile defined by a primary axial pin radius height, a primary box center point and a primary pin radius; and
iii. wherein the primary box shoulder contacts the primary pin shoulder to form a first seal.

2. The rotary shoulder connection of claim 1, wherein the first end point is co-planar with a first reference plane.

3. The rotary shoulder connection of claim 1, wherein the primary axial box radius height is from about 0.000 inch to about the length of the primary box radius in inches; and the primary axial pin radius height is from about 0.000 inch to about the length of the primary pin radius in inches.

4. The rotary shoulder connection of claim 1, wherein the primary box center point is located at about half-way between a box counter bore diameter and a pin bevel diameter; and the primary pin center point is located at about half-way between the box counter bore diameter and the pin bevel diameter.

5. The rotary shoulder connection of claim 1, wherein the primary box radius is greater than about [(pin bevel diameter−box counter bore diameter)/4] inches; and the primary pin radius is greater than about [(pin bevel diameter−box counter bore diameter)/4] inches.

6. The rotary shoulder connection of claim 1, wherein the primary box radius is about equal to the primary pin radius to form the first seal.

7. The rotary shoulder connection of claim 1, wherein the primary box radius is slightly different than the primary pin radius to form the first seal.

8. The rotary shoulder connection of claim 1, wherein the primary box shoulder is convex shaped and the primary pin shoulder is concave shaped.

9. The rotary shoulder connection of claim 1, wherein the primary box shoulder has one or more of a first flat region at an inner edge of the first curved profile and a first angled flat region at an outer edge of the first curved profile; and the primary pin shoulder has one or more of a second flat region at an inner edge of the first curved profile and a third flat region at an outer edge of the first curved profile.

10. The rotary shoulder connection of claim 9, wherein the primary box radius is greater than about [(pin bevel diameter−box counter bore diameter)/4] inches; and the primary pin radius is greater than about [(pin bevel diameter−box counter bore diameter)/4] inches.

11. The rotary shoulder connection of claim 1, wherein the box thread form comprises a first box thread crest, a second box thread crest, a first box thread flank, a second box thread flank, a box included angle between the first box thread flank and the second box thread flank, and a box thread root, and wherein the pin thread form comprises a first pin thread crest, a second pin thread crest, a first pin thread flank, a second pin thread flank, a pin included angle between the first pin thread flank and the second pin thread flank, and a pin thread root.

12. The rotary shoulder connection of claim 11, wherein the box thread form is selected from the group consisting of square, triangular, trapezoidal, and variations thereof, and wherein the pin thread form is selected from the group consisting of square, triangular, trapezoidal, and variations thereof.

13. The rotary shoulder connection of claim 11, wherein the first box thread crest and/or the second box thread crest is circular, square, triangular or trapezoidal shaped; and wherein the first pin thread crest and/or the second pin thread crest is circular, square, triangular or trapezoidal shaped.

14. The rotary shoulder connection of claim 11, wherein the first box thread flank and/or the second box thread flank are concave, convex, or straight shaped, and wherein the first pin thread flank and/or the second pin thread flank are concave, convex, or straight shaped.

15. The rotary shoulder connection of claim 11, wherein the box thread root is circular, square, triangular or trapezoidal shaped, and wherein the pin thread root is circular, square, triangular or trapezoidal shaped.

16. The rotary shoulder connection of claim 11, wherein the box included angle is from about 29 degrees to about 90 degrees, and wherein the pin included angle is from about 29 degrees to about 90 degrees.

17. The rotary shoulder connection of claim 11, wherein the box thread form is triangular and the box included angle is about 60 degrees, and wherein the pin thread form is triangular shaped and the pin included angle is about 60 degrees.

18. The rotary shoulder connection of claim 1, wherein the box threads and/or the pin threads are treated by one or more of cold rolling, shot peening, phosphating, fluoropolymer coating, ceramic coating, chrome plating, anodizing, and variations thereof.

19. The rotary shoulder connection of claim 1, wherein the box threads and/or the pin threads are treated by one or more of cold rolling, shot peening, fluoropolymer coating, and anodizing.

20. The rotary shoulder connection of claim 1 further comprising one or more of a box boreback, a box stress relief groove and a pin stress relief groove.

21. The rotary shoulder connection of claim 1, wherein the rotary shoulder connection is made from one or more of low alloy steels, stainless steels, super alloys, titanium alloys, copper alloys, cobalt alloys, aluminum alloys, and variations thereof.

22. The rotary shoulder connection of claim 1, wherein the rotary shoulder connection is made from one or more of low alloy steels, stainless steels, and variations thereof.

23. The rotary shoulder connection of claim 1, wherein the rotary shoulder connection is applied to one or more of drill pipe, heavy weight drill pipe, drill collars, pup joints, crossover subs, saver subs, bit subs, float subs, pump-in subs, inside blowout preventers, top drive shafts, top drive valves, safety valves, kelly valves, hoisting equipment, swivels, fishing tools, mud motors, rotary steerable tools, drill bits, directional drilling bottom hole assembly components, measurement while drilling components, logging while drilling components, well cleanout tools, completion tools, and variations thereof.

24. The rotary shoulder connection of claim 1, wherein the rotary shoulder connection is applied to one or more of drill pipe, heavy weight drill pipe, drill collars, pup joints, and variations thereof.

25. The rotary shoulder connection of claim 1, further comprising:
(a) a secondary shoulder connection at a second end of the box connection and a second end of the pin connection comprising:
i. A secondary box shoulder with a third curved profile defined by a secondary axial box radius height, a secondary box center point and a secondary box radius;
ii. A secondary pin shoulder with a fourth curved profile defined by a secondary axial pin radius height, a secondary pin center point and a secondary pin radius; and
iii. wherein the secondary box shoulder contacts the secondary pin shoulder to form a torque shoulder.

26. The rotary shoulder connection of claim 25, wherein the second end is offset a first distance from the first end.

27. The rotary shoulder connection of claim 26, wherein the first distance is from about 2 inches to about 8 inches.

28. The rotary shoulder connection of claim 26, wherein the first distance is a connection length.

29. The rotary shoulder connection of claim 25, wherein the secondary axial box radius height is from about 0.000 inch to about the length of the secondary box radius in inches; and the secondary axial pin radius height is from about 0.000 inch to about the length of the secondary pin radius in inches.

30. The rotary shoulder connection of claim 25, wherein the secondary box center point is located at about half-way between a pin nose outer diameter and a pin nose inner diameter; and the secondary pin center point is located at about half-way between the pin nose outer diameter and the pin nose inner diameter.

31. The rotary shoulder connection of claim 25, wherein the secondary box radius is greater than about [(pin nose outer diameter−pin nose inner diameter)/4] inches; and the secondary pin radius is greater than about [(pin nose outer diameter−pin nose inner diameter)/4] inches.

32. The rotary shoulder connection of claim 25, wherein the secondary box radius is about equal to the secondary pin radius to form the torque shoulder.

33. The rotary shoulder connection of claim 25, wherein the secondary box radius is slightly different than the secondary pin radius to form the torque shoulder.

34. The rotary shoulder connection of claim 25, wherein the secondary box shoulder is concave shaped and the secondary pin shoulder is convex shaped.

35. The rotary shoulder connection of claim 25, wherein the secondary box shoulder has one or more of a fourth flat region at an inner edge of the second curved profile and a fifth flat region at an outer edge of the second curved profile; and the secondary pin shoulder has one or more of a sixth flat region at an inner edge of the second curved profile and a second angled region at an outer edge of the second curved profile.

36. The rotary shoulder connection of claim 35, wherein the primary box radius is greater than about [(pin bevel diameter−box counter bore diameter)/4] inches; and the primary pin radius is greater than about [(pin bevel diameter−box counter bore diameter)/4] inches.

37. The rotary shoulder connection of claim 25, wherein the box thread form comprises a first box thread crest, a second box thread crest, a first box thread flank, a second box thread flank, a box included angle between the first box thread flank and the second box thread flank, and a box thread root, and wherein the pin thread form comprises a first pin thread crest, a second pin thread crest, a first pin thread flank, a second pin thread flank, a pin included angle between the first pin thread flank and the second pin thread flank, and a pin thread root.

38. The rotary shoulder connection of claim 37, wherein the box thread form is selected from the group consisting of square, triangular, trapezoidal, and variations thereof, and wherein the pin thread form is selected from the group consisting of square, triangular, trapezoidal, and variations thereof.

39. The rotary shoulder connection of claim 37, wherein the first box thread crest and/or the second box thread crest is circular, square, triangular or trapezoidal shaped, and wherein the first pin thread crest and/or the second pin thread crest is circular, square, triangular or trapezoidal shaped.

40. The rotary shoulder connection of claim 37, wherein the first box thread flank and/or the second box thread flank are concave, convex, or straight shaped, and wherein the first pin thread flank and/or the second pin thread flank are concave, convex, or straight shaped.

41. The rotary shoulder connection of claim 37, wherein the box thread root is circular, square, triangular or trapezoidal shaped, and wherein the pin thread root is circular, square, triangular or trapezoidal shaped.

42. The rotary shoulder connection of claim 37, wherein the box included angle is from about 29 degrees to about 90 degrees, and wherein the pin included angle is from about 29 degrees to about 90 degrees.

43. The rotary shoulder connection of claim 37, wherein the box thread form is triangular and the box included angle is about 60 degrees, and wherein the pin thread form is triangular shaped and the pin included angle is about 60 degrees.

44. The rotary shoulder connection of claim 25, wherein the box threads and/or the pin threads are treated by one or more of cold rolling, shot peening, phosphating, fluoropolymer coating, ceramic coating, chrome plating, anodizing, and variations thereof.

45. The rotary shoulder connection of claim 25, wherein the box threads and/or the pin threads are treated by one or more of cold rolling, shot peening, fluoropolymer coating, and anodizing.

46. The rotary shoulder connection of claim 25 further comprising one or more of a box boreback, a box stress relief groove and a pin stress relief groove.

47. The rotary shoulder connection of claim 25, wherein the rotary shoulder connection is made from one or more of low alloy steels, stainless steels, super alloys, titanium alloys, copper alloys, cobalt alloys, aluminum alloys, and variations thereof.

48. The rotary shoulder connection of claim 25, wherein the rotary shoulder connection is made from one or more of low alloy steels, stainless steels, and variations thereof.

49. The rotary shoulder connection of claim 25, wherein the rotary shoulder connection is applied to one or more of drill pipe, heavy weight drill pipe, drill collars, pup joints, crossover subs, saver subs, bit subs, float subs, pump-in subs, inside blowout preventers, top drive shafts, top drive valves, safety valves, kelly valves, hoisting equipment, swivels, fishing tools, mud motors, rotary steerable tools, drill bits, directional drilling bottom hole assembly components, measurement while drilling components, logging while drilling components, well cleanout tools, completion tools, and variations thereof.

50. The rotary shoulder connection of claim 25, wherein the rotary shoulder connection is applied to one or more of drill pipe, heavy weight drill pipe, drill collars, pup joints, and variations thereof.

51. The rotary shoulder connection of claim 1, further comprising:
(a) a secondary shoulder connection at a second end of the box connection and a second end of the pin connection comprising:
i. A secondary box shoulder at a secondary box angle with respect to a second perpendicular to the box axis at a second end point, wherein the secondary box angle is from greater than or equal to about 0 degrees to less than or equal to 15 degrees;
ii. A secondary pin shoulder at a secondary pin angle with respect to the second perpendicular to the pin axis at the second end point, wherein the secondary pin angle is from greater than or equal to about 0 degrees to less than or equal to about 15 degrees; and
iii. wherein the secondary box shoulder contacts the secondary pin shoulder to form a torque shoulder.

52. The rotary shoulder connection of claim 51, wherein the second end is offset a first distance from the first end.

53. The rotary shoulder connection of claim 52, wherein the first distance is a connection length.

54. The rotary shoulder connection of claim 51, wherein the secondary box angle is from greater than or equal to about 0 degrees to less than or equal to about 10 degrees and the secondary pin angle is from greater than or equal to about 0 degrees to less than or equal to about 10 degrees.

55. The rotary shoulder connection of claim 51, wherein the secondary box angle is about 5 degrees and the secondary pin angle is about 5 degrees.

56. The rotary shoulder connection of claim 51, wherein the secondary box angle is about 0 degrees and the secondary pin angle is about 0 degrees.

57. The rotary shoulder connection of claim 51, wherein the secondary box angle is about equal to the secondary pin angle to form the torque shoulder.

58. The rotary shoulder connection of claim 51, wherein the secondary box angle is slightly different than the secondary pin angle to form the torque shoulder.

59. The rotary shoulder connection of claim 51, wherein the secondary box shoulder is conical shaped (outside of cone, male) and the secondary pin shoulder is conical shaped (inside of cone, female).

60. The rotary shoulder connection of claim 51, wherein the box thread form comprises a first box thread crest, a second box thread crest, a first box thread flank, a second box thread flank, a box included angle between the first box thread flank and the second box thread flank, and a box thread root, and wherein the pin thread form comprises a first pin thread crest, a second pin thread crest, a first pin thread flank, a second pin thread flank, a pin included angle between the first pin thread flank and the second pin thread flank, and a pin thread root.

61. The rotary shoulder connection of claim 60, wherein the box thread form is selected from the group consisting of square, triangular, trapezoidal, and variations thereof, and wherein the pin thread form is selected from the group consisting of square, triangular, trapezoidal, and variations thereof.

62. The rotary shoulder connection of claim 60, wherein the box thread crest is circular, square, triangular or trapezoidal shaped, and wherein the pin thread crest is circular, square, triangular or trapezoidal shaped.

63. The rotary shoulder connection of claim 60, wherein the first box thread flank and/or the second box thread flank are concave, convex, or straight shaped, and wherein the first pin thread flank and/or the second pin thread flank are concave, convex, or straight shaped.

64. The rotary shoulder connection of claim 60, wherein the box thread root is circular, square, triangular or trapezoidal shaped, and wherein the pin thread root is circular, square, triangular or trapezoidal shaped.

65. The rotary shoulder connection of claim 60, wherein the box included angle is from about 29 degrees to about 90 degrees, and wherein the pin included angle is from about 29 degrees to about 90 degrees.

66. The rotary shoulder connection of claim 60, wherein the box thread form is triangular and the box included angle is about 60 degrees, and wherein the pin thread form is triangular shaped and the pin included angle is about 60 degrees.

67. The rotary shoulder connection of claim 51, wherein the box threads and/or the pin threads are treated by one or more of cold rolling, shot peening, phosphating, fluoropolymer coating, ceramic coating, chrome plating, anodizing, and variations thereof.

68. The rotary shoulder connection of claim 51, wherein the box threads and/or the pin threads are treated by one or more of cold rolling, shot peening, fluoropolymer coating, and anodizing.

69. The rotary shoulder connection of claim 51 further comprising one or more of a box boreback, a box stress relief groove and a pin stress relief groove.

70. The rotary shoulder connection of claim 51, wherein the rotary shoulder connection is made from one or more of low alloy steels, stainless steels, super alloys, titanium alloys, copper alloys, cobalt alloys, aluminum alloys, and variations thereof.

71. The rotary shoulder connection of claim 51, wherein the rotary shoulder connection is made from one or more of low alloy steels, stainless steels, and variations thereof.

72. The rotary shoulder connection of claim 51, wherein the rotary shoulder connection is applied to one or more of drill pipe, heavy weight drill pipe, drill collars, pup joints, crossover subs, saver subs, bit subs, float subs, pump-in subs, inside blowout preventers, top drive shafts, top drive valves, safety valves, kelly valves, hoisting equipment, swivels, fishing tools, mud motors, rotary steerable tools, drill bits, directional drilling bottom hole assembly components, measurement while drilling components, logging while drilling components, well cleanout tools, completion tools, and variations thereof.

73. The rotary shoulder connection of claim 51, wherein the rotary shoulder connection is applied to one or more of drill pipe, heavy weight drill pipe, drill collars, pup joints, and variations thereof.

74. A rotary shoulder connection comprising:
(a) A box connection having a box axis, wherein the box connection has a box outer radius, a box counter bore radius and a box inner radius, and box threads having a box thread form cut along a box taper;
(b) A pin connection having a pin axis, wherein the pin connection has a pin nose inner radius, a pin outer radius, a pin cylinder radius and a pin nose radius, and pin threads having a pin thread form cut along a pin taper to align with the box threads inside the box connection; and
(c) A primary shoulder connection at a first end of the box connection and a first end of the pin connection comprising:
i. A primary box shoulder at a primary box angle with respect to a first perpendicular to the box axis at a first end point, wherein the primary box angle is from greater than or equal to about 0 degrees to less than or equal to about 15 degrees;
ii. A primary pin shoulder at a primary pin angle with respect to the first perpendicular to the pin axis at the first end point, wherein the primary pin angle is from greater than or equal to about 0 degrees to less than or equal to about 15 degrees;
iii. wherein the primary box shoulder contacts the primary pin shoulder to form a first seal; and
(d) a secondary shoulder connection at a second end of the box connection and a second end of the pin connection comprising:
i. A secondary box shoulder with a first curved profile defined by a secondary axial box radius height, a secondary box center point and a secondary box radius;
ii. A secondary pin shoulder with a second curved profile defined by a secondary axial pin radius height, a secondary pin center point and a secondary pin radius; and
iii. wherein the secondary box shoulder contacts the secondary pin shoulder to form a torque shoulder.

75. The rotary shoulder connection of claim 74, wherein the second end is offset a first distance from the first end.

76. The rotary shoulder connection of claim 75, wherein the first distance is from about 2 inches to about 8 inches.

77. The rotary shoulder connection of claim 75, wherein the first distance is a connection length.

78. The rotary shoulder connection of claim 74, wherein the secondary axial box radius height is from about 0.000 inch to about the length of the secondary box radius in inches; and the secondary axial pin radius height is from about 0.000 inch to about the length of the secondary pin radius in inches.

79. The rotary shoulder connection of claim 74, wherein the secondary box center point is located at about half-way between a pin nose outer diameter and a pin nose inner diameter; and the secondary pin center point is located at about half-way between the pin nose outer diameter and the pin nose inner diameter.

80. The rotary shoulder connection of claim 74, wherein the secondary box radius is greater than about [(pin nose outer diameter−pin nose inner diameter)/4] inches; and the secondary pin radius is greater than about [(pin nose outer diameter−pin nose inner diameter)/4] inches.

81. The rotary shoulder connection of claim 74, wherein the secondary box radius is about equal to the secondary pin radius to form the torque shoulder.

82. The rotary shoulder connection of claim 74, wherein the secondary box radius is slightly different than the secondary pin radius to form the torque shoulder.

83. The rotary shoulder connection of claim 74, wherein the secondary box shoulder is concave shaped and the secondary pin shoulder is convex shaped.

84. The rotary shoulder connection of claim 74, wherein the secondary box shoulder has one or more of a fourth flat region at an inner edge of the second curved profile and a fifth flat region at an outer edge of the second curved profile; and the secondary pin shoulder has one or more of a sixth flat region at an inner edge of the second curved profile and a second angled region at an outer edge of the second curved profile.

85. The rotary shoulder connection of claim 74, wherein the box thread form comprises a first box thread crest, a second box thread crest, a first box thread flank, a second box thread flank, a box included angle between the first box thread flank and the second box thread flank, and a box thread root, and wherein the pin thread form comprises a first pin thread crest, a second pin thread crest, a first pin thread flank, a second pin thread flank, a pin included angle between the first pin thread flank and the second pin thread flank, and a pin thread root.

86. The rotary shoulder connection of claim 85, wherein the box thread form is selected from the group consisting of square, triangular, trapezoidal, and variations thereof, and wherein the pin thread form is selected from the group consisting of square, triangular, trapezoidal, and variations thereof.

87. The rotary shoulder connection of claim 85, wherein the first box thread crest and/or the second box thread crest is circular, square, triangular or trapezoidal shaped, and wherein the first pin thread crest and/or the second pin thread crest is circular, square, triangular or trapezoidal shaped.

88. The rotary shoulder connection of claim 85, wherein the first box thread flank and/or the second box thread flank are concave, convex, or straight shaped, and wherein the first pin thread flank and/or the second pin thread flank are concave, convex, or straight shaped.

89. The rotary shoulder connection of claim 85, wherein the box thread root is circular, square, triangular or trapezoidal shaped, and wherein the pin thread root is circular, square, triangular or trapezoidal shaped.

90. The rotary shoulder connection of claim 85, wherein the box included angle is from about 29 degrees to about 90 degrees, and wherein the pin included angle is from about 29 degrees to about 90 degrees.

91. The rotary shoulder connection of claim 85, wherein the box thread form is triangular and the box included angle is about 60 degrees, and wherein the pin thread form is triangular shaped and the pin included angle is about 60 degrees.

92. The rotary shoulder connection of claim 74, wherein the box threads and/or the pin threads are treated by one or more of cold rolling, shot peening, phosphating, fluoropolymer coating, ceramic coating, chrome plating, anodizing, and variations thereof.

93. The rotary shoulder connection of claim 74, wherein the box threads and/or the pin threads are treated by one or more of cold rolling, shot peening, fluoropolymer coating, and anodizing.

94. The rotary shoulder connection of claim 74 further comprising one or more of a box boreback, a box stress relief groove and a pin stress relief groove.

95. The rotary shoulder connection of claim 74, wherein the rotary shoulder connection is made from one or more of low alloy steels, stainless steels, super alloys, titanium alloys, copper alloys, cobalt alloys, aluminum alloys, and variations thereof.

96. The rotary shoulder connection of claim 74, wherein the rotary shoulder connection is made from one or more of low alloy steels, stainless steels, and variations thereof.

97. The rotary shoulder connection of claim 74, wherein the rotary shoulder connection is applied to one or more of drill pipe, heavy weight drill pipe, drill collars, pup joints, crossover subs, saver subs, bit subs, float subs, pump-in subs, inside blowout preventers, top drive shafts, top drive valves, safety valves, kelly valves, hoisting equipment, swivels, fishing tools, mud motors, rotary steerable tools, drill bits, directional drilling bottom hole assembly components, measurement while drilling components, logging while drilling components, well cleanout tools, completion tools, and variations thereof.

98. The rotary shoulder connection of claim 74, wherein the rotary shoulder connection is applied to one or more of drill pipe, heavy weight drill pipe, drill collars, pup joints, and variations thereof.

99. A method of using a rotary shoulder connection comprising:
(a) providing the rotary shoulder connection of claim 1; and
(b) applying the rotary shoulder connection to one or more products.

100. The method of claim 99, further comprising tightening the rotary shoulder connection between one of more products to form the first seal.

101. A method of using a rotary shoulder connection comprising:
(a) providing the rotary shoulder connection of claim 25; and
(b) applying the rotary shoulder connection to one or more products.

102. The method of claim 101 further comprising tightening the rotary shoulder connection between the one or more products to form the first seal.

103. The method of claim 101 further comprising tightening the rotary shoulder connection between the one or more products to form the first seal and the torque shoulder.

104. A method of using a rotary shoulder connection comprising:
(a) providing the rotary shoulder connection of claim 47; and
(b) applying the rotary shoulder connection to one or more products.

105. The method of claim 104 further comprising tightening the rotary shoulder connection between the one or more products to form the first seal.

106. The method of claim 104 further comprising tightening the rotary shoulder connection between the one or more products to form the first seal and the torque shoulder.

107. A method of using a rotary shoulder connection comprising:
(a) providing the rotary shoulder connection of claim 74; and
(b) applying the rotary shoulder connection to one or more products.

108. The method of claim 107 further comprising tightening the rotary shoulder connection between the one or more products to form the first seal.

109. The method of claim 107 further comprising tightening the rotary shoulder connection between the one or more products to form the first seal and the torque shoulder.

110. A method for determining a primary shoulder location comprising:
(a) locating a pitch line parallel to a connection box/pin taper;
(b) locating a first intersection of a pitch diameter and the pitch line;
(c) locating a first perpendicular to the connection box/pin axis at the first intersection;
(d) locating a second perpendicular to the connection box/pin axis at a first distance towards a primary box/pin shoulder from the first perpendicular;
(e) locating a first reference plane, and, optionally, locating a second intersection of the pitch line and the second perpendicular; and
(f) selecting a primary axial box/pin radius height, selecting a primary box/pin radius, and locating a primary box/pin center point between a box counter bore diameter and a pin bevel diameter.

111. The method of claim 110, further comprising step (g) defining a primary box/pin curved profile with respect to primary axial box/pin radius height, the primary box/pin center point and the primary box/pin radius, and, optionally, defining a primary box/pin angle with respect to the second perpendicular at the second intersection.

112. The method of claim 110 further comprising step (f) defining a primary box/pin angle with respect to the second perpendicular at the second intersection.

113. The method of claim 110, wherein the first distance is from about 0.5 inch to about 2.50 inches.

114. The method of claim 110, wherein the first distance is from about 0.625 inch to about 2.250 inches.

115. The method of claim 110, wherein the first distance is about 0.625 inch.

116. A method for determining a secondary shoulder connection location comprising:
(a) locating a pitch line parallel to a connection box/pin taper;
(b) locating a first intersection of a pitch diameter and the pitch line;
(c) locating a first perpendicular to the connection box/pin axis at the first intersection;
(d) locating a second perpendicular to the connection box/pin axis at a first distance towards a primary box/pin shoulder from the first perpendicular;
(e) locating a first reference plane, and, optionally, locating a second intersection of the pitch line and the second perpendicular;
(f) locating a third perpendicular to the connection box/pin axis at a second distance toward a secondary box/pin shoulder;
(g) locating a second reference plane, and, optionally, locating a third intersection of a pin nose outer diameter and the third perpendicular; and
(h) selecting a secondary axial box/pin radius height, selecting a secondary box/pin radius, and locating a secondary box/pin center point between a pin nose outer diameter and a pin nose inner diameter.

117. The method of claim 116 further comprising step (i) defining a secondary box/pin curved profile with respect to secondary axial box/pin radius height, the secondary box/pin center point and the secondary box/pin radius, and, optionally, defining a secondary box/pin angle with respect to the third perpendicular at the third intersection.

118. The method of claim 116 further comprising step (j) optionally, defining a primary box/pin angle with respect to the second perpendicular at the second intersection.

119. The method of claim 116 further comprising step (k) optionally, defining a secondary box/pin angle with respect to the third perpendicular at the third intersection.

120. The method of claim 116, wherein the second distance is from about 2 inches to about 8 inches.

121. The method of claim 116, wherein the second distance is a connection length.
